(19) United States
(12) Patent Application Publication
(10) Pub. No.: US 2022/0237549 A1
(43) Pub. Date: Jul. 28, 2022

(54) HUMAN RESOURCE ALLOCATION SUPPORTING SYSTEM AND METHOD

(71) Applicant: HITACHI, LTD., Tokyo (JP)

(72) Inventors: Itoe AKUTSU, Tokyo (JP); Tatsuhiro SATOU, Tokyo (JP); Kenya WADA, Tokyo (JP); Fumiya SUEYOSHI, Tokyo (JP); Toshiyuki UKAI, Tokyo (JP)

(21) Appl. No.: 17/438,539

(22) PCT Filed: Nov. 2, 2020
(86) PCT No.: PCT/JP2020/041124

§ 371 Date: Sep. 13, 2021

(51) Int. Cl. G06Q 10/06

(52) U.S. Cl. CPC G06Q 10/063112; G06Q 10/06398

(57) ABSTRACT

A system calculates, by executing an optimum parameter model, an optimum parameter group used to generate an allocation plan based on input data including all or part of allocation information of human resources in an organization. The optimum parameter model is a machine learning model to which the input data is input and from which an optimum parameter group is output. For each time point, the system generates an allocation plan based on the input data corresponding to the time point and based on a given parameter group, and calculates an optimum parameter group based on the allocation plan, correct data that obeys manual correction of the allocation plan, and the given parameter group. The system performs learning of the optimum parameter model based on a data set (including the input data or a characteristic amount of the input data, and the optimum parameter group) for each time point.

### TECHNICAL FIELD

The present invention generally relates to a technology of supporting human resource allocation.

### BACKGROUND ART

For example, a system disclosed in Patent Literature 1 is known as a system related to human resource allocation support. The system disclosed in Patent Literature 1 generates matching information related to a human resource by comparing human resource role definition information and human resource working-way definition information with internal human resource information and external human resource information, and generates human resource allocation information based on the matching information.

### CITATION LIST

### Patent Literature

[Patent Literature 1]

Japanese Patent Laid-open No. 2019-96188

### SUMMARY OF INVENTION

### Technical Problem

When a human resource allocation plan (plan of which human resource is to be allocated to which allocation destination) generated by a system cannot be directly employed, an employable allocation plan can be obtained by manually correcting the human resource allocation plan (hereinafter referred to as allocation plan). It is desirable that the system generates an allocation plan that needs a small amount of manual correction.

Patent Literature 1 has no disclosure nor suggestion on manual correction of an allocation plan. Thus, according to Patent Literature 1, even when an employable allocation plan is obtained by manually correcting a generated allocation plan, the same matching information is obtained upon inputting of the same role definition information, working-way definition information, internal human resource information, and external human resource information again, and as a result, an allocation plan same as before the manual correction is generated.

### Solution to Problem

A system calculates an optimum parameter group by executing an optimum parameter model based on input data including all or part of allocation information indicating allocation of each of one or a plurality of human resources in an organization. The system generates an allocation plan based on the calculated optimum parameter group (or the optimum parameter group subjected to manual correction) and input data including all or part of the allocation information, and outputs the allocation plan.

The optimum parameter model is a machine learning model to which input data including all or part of the allocation information is input and from which an optimum parameter group is output. The optimum parameter group includes an optimum parameter for each of one or more condition items related to change of the allocation destinations of the human resources. The allocation plan is a post-change allocation destination plan of each of one or more human resources of the one or plurality of human resources.

For each of one or more time points, the system generates an allocation plan based on input data including all or part of the allocation information corresponding to the time point and based on a given parameter group of a given parameter for each of the one or more condition items, and calculates an optimum parameter group based on the allocation plan, correct data that obeys manual correction of the allocation plan, and the given parameter group. The system performs learning of the optimum parameter model based on a data set for each of one or more time points. For each of one or more time points, the data set includes an optimum parameter group for the time point and input data including all or part of the allocation information corresponding to the time point (or a characteristic amount of the input data).

### Advantageous Effects of Invention

According to the present invention, generation of an allocation plan that needs a small amount of manual correction is expected.

### BRIEF DESCRIPTION OF DRAWINGS

FIG. 1 illustrates an exemplary configuration of a human resource allocation supporting system according to Embodiment 1.

FIG. 2 illustrates an example of a condition setting UI.

FIG. 3 illustrates an example of an allocation plan UI.

FIG. 4 illustrates an example of a survey analysis UI.

FIG. 5 illustrates an exemplary configuration of an input DB.

FIG. 6 illustrates an exemplary configuration of an allocation plan DB.

FIG. 7 illustrates an exemplary configuration of a correction DB.

FIG. 8 illustrates an exemplary configuration of a survey result DB.

FIG. 9 illustrates an exemplary configuration of a parameter DB.

FIG. 10 schematically illustrates an outline of an example of data for each of a plurality of time points before start of a learning phase.

FIG. 11 illustrates a flowchart of learning processing.

FIG. 12 illustrates a detailed flowchart of S1103 in FIG. 11.

FIG. 13 schematically illustrates an example of calculation of an optimum parameter group in the learning processing.

FIG. 14 schematically illustrates an example of calculation of a parameter (continuous value).

FIG. 15 schematically illustrates an example of calculation of a parameter (discrete value).

FIG. 16 illustrates an example of learning according to Embodiment 2.

FIG. 17 illustrates an example of recommendation according to Embodiment 2.

FIG. 18 illustrates a description example of model estimation based on a post-manual-correction allocation plan.

FIG. 19 illustrates a description example of model estimation based on a parameter group.

FIG. 20 illustrates an example of an optimum parameter model according to Embodiment 2.

FIG. 21 illustrates a flowchart of learning processing according to Embodiment 2.

### DESCRIPTION OF EMBODIMENTS

In the following description, an “interface apparatus” may be one or more interface devices. The one or more interface devices may be at least one of those described below.

One or more input/output (I/O) interface devices. An input/output (I/O) interface device is an interface device for at least one of an I/O device and a remote display calculator. The I/O interface device for the display calculator may be a communication interface device. At least one I/O device may be any of user interface devices, for example, an input device such as a keyboard or a pointing device, or an output device such as a display device.

One or more communication interface devices. One or more communication interface devices may be one or more communication interface devices (for example, one or more network interface cards (NICs)) of the same kind or may be communication interface devices (for example, an NIC and a host bus adapter (HBA)) of two or more different kinds.

In the following description, a “memory” is one or more memory devices as examples of one or more storage devices and may be typically a main storage device. At least one memory device in the memory may be a volatile memory device or a non-volatile memory device.

In the following description, a “permanent storage apparatus” may be one or more permanent storage devices as examples of one or more storage devices. Each permanent storage device may be typically a non-volatile storage device (for example, an auxiliary storage device), and specifically, may be for example, a hard disk drive (HDD), a solid state drive (SSD), a non-volatile memory express (NVME) drive, or a storage class memory (SCM).

In the following description, a “storage apparatus” may be at least a memory among the memory and a permanent storage apparatus.

In the following description, a “processor” may be one or more processor devices. At least one processor device may be typically a microprocessor device such as a central processing unit (CPU) but may be a processor device of another kind such as a graphics processing unit (GPU). At least one processor device may have a single-core structure or a multi-core structure. At least one processor device may be a processor core. At least one processor device may be a processor device in a broad sense, such as a circuit (for example, a field-programmable gate array (FPGA), a complex programmable logic device (CPLD), or an application specific integrated circuit (ASIC)) as an assembly of gate arrays, which performs part or all of processing by a hardware description language.

In the following description, a function is described in an expression of “yyy unit” in some cases, but the function may be achieved as one or more computer programs are executed by a processor, may be achieved by one or more hardware circuits (for example, FPGA or ASIC), or may be achieved by combination thereof. When a function is achieved as a computer program are executed by a processor, determined processing is performed by using, for example, a storage apparatus and/or an interface apparatus as appropriate, and thus the function may be at least part of the processor. Processing described with a function as a subject may be processing performed by a processor or an apparatus including the processor. A computer program may be installed from a computer program source. The computer program source may be, for example, a computer program distributing calculator or a calculator-readable recording medium (for example, a non-temporary recording medium). Description of each function is exemplary, a plurality of functions may be collected as one function, and one function may be divided into a plurality of functions.

In the following description, processing is described with a “computer program” as a subject in some cases, but such processing described with a computer program as a subject may be processing performed by a processor or an apparatus including the processor. Two or more computer programs may be achieved as one computer program, and one computer program may be achieved as two or more computer programs.

In the following description, information from which an output can be obtained in response to an input is described in an expression of a “ppp table” (or ppp DB) in some cases, but the information may have any structure. Thus, the “ppp table” (or “ppp DB”) can be referred to as “ppp information”. In the following description, the configuration of each table is exemplary, one table may be divided into two or more tables, and all or part of two or more tables may be one table.

In the following description, a “human resource allocation supporting system” may be a system including one or more physical calculators or may be a system (for example, a cloud computing system) achieved on a physical calculation resource group (for example, a cloud foundation). “Display” of display information by the human resource allocation supporting system may be display of the display information on a display device included in a calculator or may be transmission of the display information from a calculator to a display calculator (in the latter case, the display information is displayed by the display calculator).

### Embodiment 1

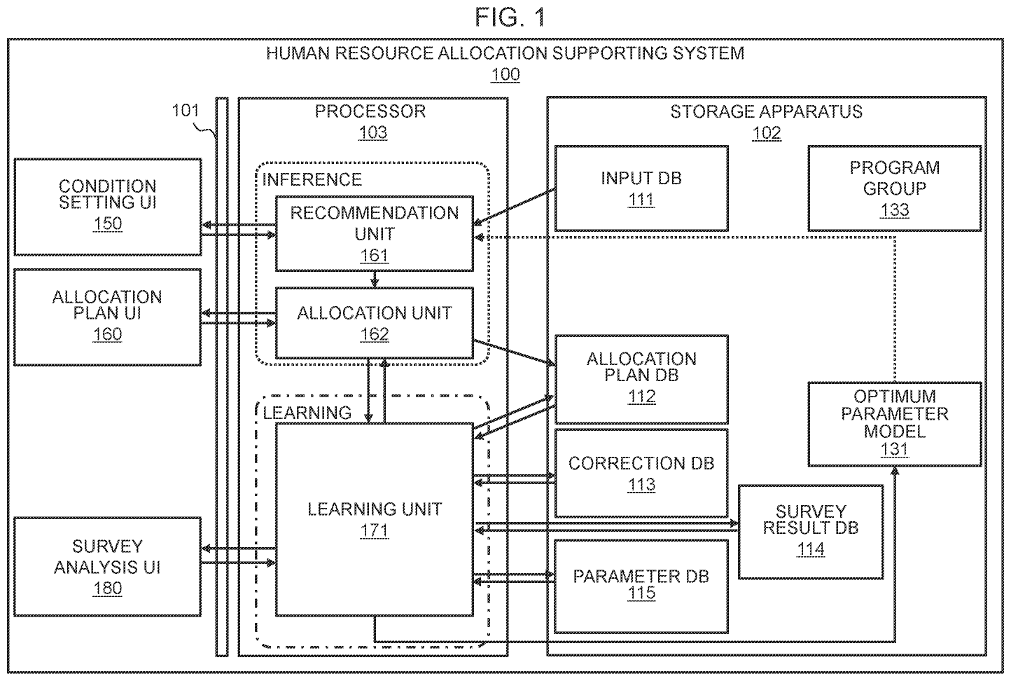

FIG. 1 illustrates an exemplary configuration of a human resource allocation supporting system according to Embodiment 1. Note that in the following description, “UI” is an abbreviation for user interface and is typically a graphical user interface (GUI).

A human resource allocation supporting system 100 is a system configured to support allocation of human resources in an organization. The “organization” is typically a company but is not limited to a company. In the present embodiment, a “department” is employed as an example of the “allocation destination” of a human resource, but the allocation destination is not limited to a department, and for example, at least one of those described below may be employed in place of or in addition to a department.

“Allocation destination” may be the “status” (typically, position) of a human resource. Thus, for example, change of the allocation destination of a human resource may be “transfer” by which the department and/or status of the human resource is changed.

“Allocation destination” may be a time period. In this case, support of production of a shift for each time period of facility maintenance is expected as an example of human resource allocation support.

“Allocation destination” may be the team (for example, an exemplary group of human resources) of a human resource. In this case, support of teaming of construction work is expected as an example of human resource allocation support.

The human resource allocation supporting system 100 includes an interface apparatus 101, a storage apparatus 102, and a processor 103 coupled with these apparatuses.

A UI is provided through the interface apparatus 101. The provided UI is displayed on a nonillustrated remote calculator coupled with the human resource allocation supporting system 100 (or a nonillustrated display device included in the human resource allocation supporting system 100). In addition, information is input by a user through the provided UI.

The storage apparatus 102 stores an input DB 111, an allocation plan DB 112, a correction DB 113, a parameter DB 114, and a survey result DB 115. The storage apparatus 102 also stores an optimum parameter model 131 and a computer program group 133 (one or more computer programs).

A recommendation unit 161, an allocation unit 162, and a learning unit 171 are achieved as the computer program group 133 is executed by the processor 103. The recommendation unit 161 calculates an optimum parameter group by executing the optimum parameter model 131. The allocation unit 162 generates an allocation plan by executing an allocation model (typically a mathematical optimization model). The models 131 and 132 may be each an optional model. For example, the optimum parameter model 131 is a model to which input data including the input DB 111 is input to calculate (predict) an optimum parameter group, and therefore, is preferably a machine learning model.

In an inference phase, for example, processing as follows is performed. Specifically, the recommendation unit 161 provides a condition setting UI 150. The recommendation unit 161 calculates an optimum parameter group by executing the optimum parameter model 131 based on input data (specifically, for example, a characteristic amount of the input data) acquired from the input DB 111, and recommends the optimum parameter group through the condition setting UI 150. The “optimum parameter group” includes an optimum parameter for each of one or more condition items related to change of the allocation destinations of human resources. For each of the one or more condition items, the optimum parameters may be one optimum parameter or may be parameters belonging to a parameter range constituted by a plurality of continuous or discrete parameters. The recommendation unit 161 outputs, to the allocation unit 162, the input data and an optimum parameter group (including, for example, at least one of a recommended and approved optimum parameter and an optimum parameter input by the user) that obeys information input through the condition setting UI 150. The allocation unit 162 provides an allocation plan UI 160 configured to generate an allocation plan by executing the allocation model based on the input data and the optimum parameter group from the recommendation unit 161 and display the generated allocation plan. The allocation unit 162 stores, in the allocation plan DB 112, information indicating an allocation plan (for example, an approved allocation plan or an allocation plan, at least part of which is corrected by the user) that obeys information input through the allocation plan UI 160.

In a learning phase, the learning unit 171 performs learning of the optimum parameter model 131. In learning of the optimum parameter model 131, the learning unit 171 performs, as appropriate, input to and output from the allocation unit 162, provision of a survey analysis UI 180, and input to and output from the DBs 111 to 115.

In the present embodiment, the optimum parameter model 131 is learned based on data that obeys manual correction (specifically, past data including data that obeys manual correction as described later), and thus, adequacy of an optimum parameter group calculated by using the optimum parameter model 131 is improved, and accordingly, it is expected that an allocation plan generated by the allocation unit 162 by using the optimum parameter group needs a small amount of manual correction.

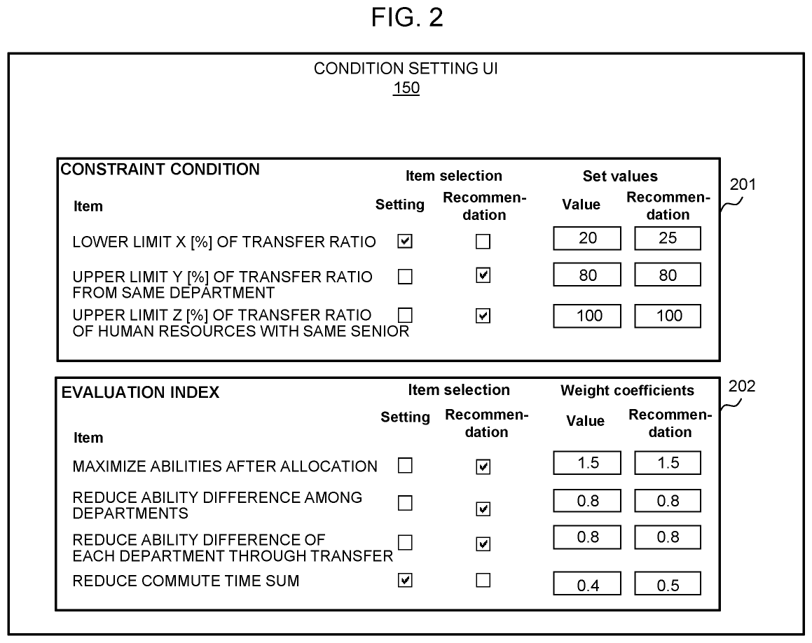

The above-described UIs and DBs will be further described below with reference to FIGS. 2 to 9.

FIG. 2 illustrates an example of the condition setting UI 150.

The condition setting UI 150 is a UI configured to receive setting of a parameter. The “setting” of a parameter through the condition setting UI 150 may be any of “approval” of a recommended parameter and “manual inputting” such as manual correction of the recommended parameter or inputting of a new parameter. The “approval” may be check of a check box corresponding to “recommendation” for a condition item for which a parameter is recommended. The “manual inputting” may be check of a check box corresponding to “setting” and inputting or correction of a parameter. An “optimum parameter” in the inference phase is a parameter set through the condition setting UI 150. In the inference phase, an allocation plan is generated based on an optimum parameter group set through the condition setting UI 150.

The condition setting UI 150 includes a constraint condition UI 201 and an evaluation index UI 202.

The constraint condition UI 201 is a UI configured to receive setting of a parameter for each of one or more items for a constraint condition. The “constraint condition” is a condition that affects selection of a human resource. The parameter for each constraint condition item may be typically a threshold value (for example, an upper limit and/or a lower limit) but may be a value of another kind such as a continuous value or a discrete value. A human resource (candidate), the allocation destination of which is to be changed is selected by the allocation unit 162 based on the parameter set for each constraint condition item.

The evaluation index UI 202 is a UI configured to receive setting of a parameter for each of one or more items for an evaluation index. The “evaluation index” is a condition that affects the post-change allocation destination of a human resource, the allocation destination of which is to be changed. The parameter for each evaluation index item is typically a weight coefficient. The post-change allocation destination of a human resource is determined by the allocation unit 162 based on the parameter set for each evaluation index item. Note that in the following description, an expression of the sum of evaluation indexes multiplied by weight coefficients is employed as an example of an objective function, but the objective function of the evaluation indexes is not limited to such an expression.

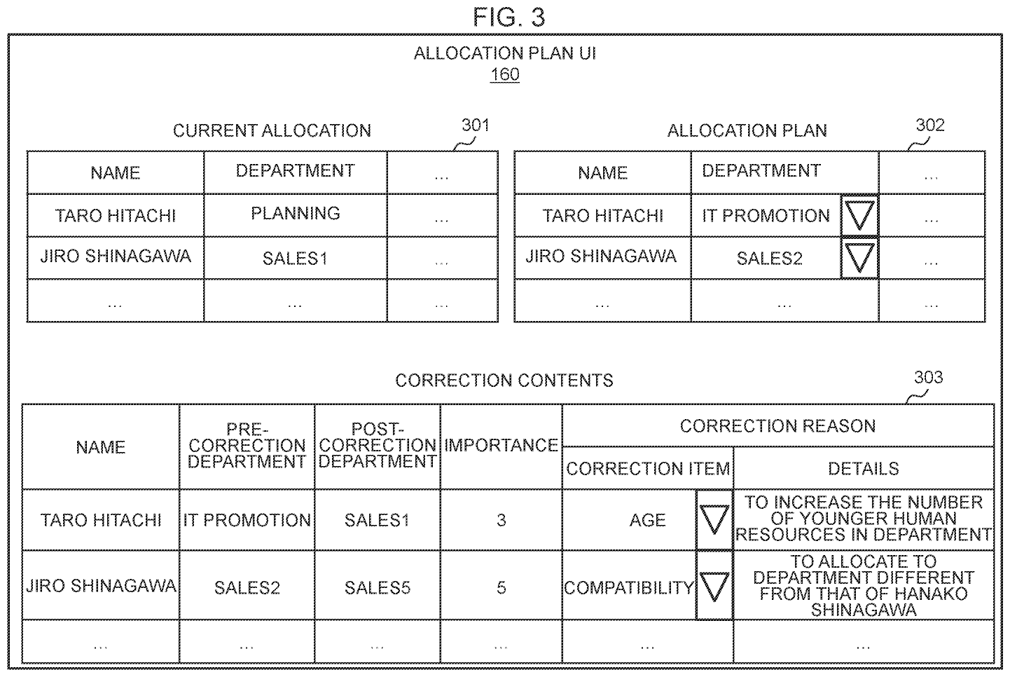

FIG. 3 illustrates an example of the allocation plan UI 160.

The allocation plan UI 160 displays a current allocation 301, an allocation plan 302, and correction contents 303.

The current allocation 301 is information included in input data acquired from the input DB 111 and is information indicating the relation between the name and current department of each human resource, the department (allocation destination) of which to be changed.

The allocation plan 302 is a plan of the post-change allocation destination of each human resource included in the current allocation 301 and is a UI configured to display information indicating an allocation plan generated by the allocation unit 162. The allocation plan 302 has, for example, a tool that receives correction on the department of each human resource. The user can correct a department in the allocation plan by operating the tool.

The correction contents 303 is a UI configured to receive manual correction of the allocation plan 302, and specifically, is a UI configured to receive details of correction performed through the tool of the allocation plan 302. For example, the correction contents 303 displays the name and pre-correction department (post-change department in the allocation plan before correction) of each human resource, the post-change department of which is corrected, displays the post-correction department (post-change department after correction) thereof, and receives inputting of an importance (importance of correction for the human resource), a correction reason (correction item (item to which the correction reason corresponds) and details (details of the correction reason)) from the user. Note that in the present embodiment, a post-change department is employed as an exemplary element that can be corrected, but a human resource, the allocation destination of which is to be changed may be corrected in place of or in addition to department correction (for example, a human resource, the allocation destination of which is to be changed may be corrected from “Taro Hitachi” to another human resource).

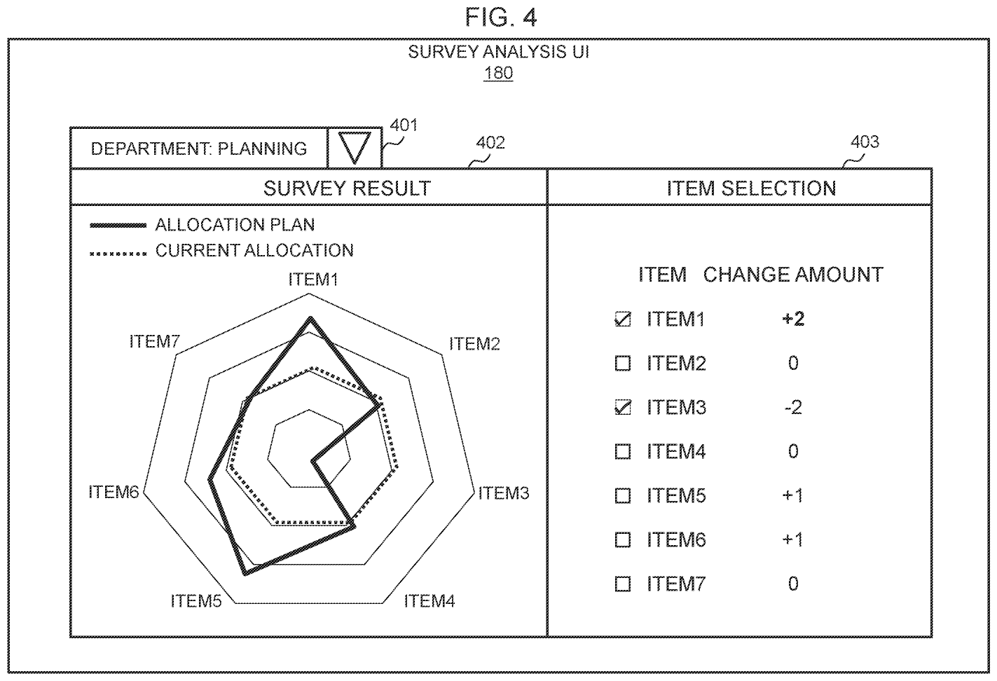

FIG. 4 illustrates an example of the survey analysis UI 180.

The survey analysis UI 180 includes a target specification UI 401, a survey result UI 402, and an item selection UI 403.

The target specification UI 401 is a UI configured to receive specification of a display target of a survey result. The target may be any of a human resource, all human resources, a department, and all departments in an allocation plan.

The survey result UI 402 is a UI configured to display, for example, a radar chart as a panoramic chart of a survey result of each of a current allocation and an allocation plan. The survey result includes a score provided for each of a plurality of survey items (in the example illustrated in FIG. 4, items 1 to 7). The survey result (specifically, scores of items 1 to 7) of each of the current allocation and the allocation plan is displayed on the radar chart.

The item selection UI 403 is a UI configured to display a change amount (value obtained by subtracting a score in the survey result of the current allocation from a score in the survey result of the allocation plan) of each of survey items 1 to 7 and receive, from the user, specification of a survey item that affects calculation of an optimum parameter group. According to the example illustrated in FIG. 4, survey item 1, the change amount of which is “+2” (a survey item for which a result that it is significantly good to change the current allocation to allocation as in the allocation plan is obtained) and survey item 3, the change amount of which is “−2” (survey item for which a result that it is significantly bad to change the current allocation to allocation as in the allocation plan is obtained) are specified. Note that a selected survey item may affect a selectable correction item. For example, a correction item that is selectable by the user among a plurality of correction items as options may be restricted to a correction item related to a selected survey item by the processor 103 (for example, the allocation unit 162 that provides the allocation plan UI 160) (for example, when survey item 1 is selected, one or more selectable correction items among a plurality of correction items may be “age” and “compatibility”). More specifically, for example, information indicating the correspondence relation a survey item and a selectable correction item may be stored in the storage apparatus 102, and the processor 103 may display a correction item corresponding (related) to one or more selected survey items so that the correction item can be selected by the user.

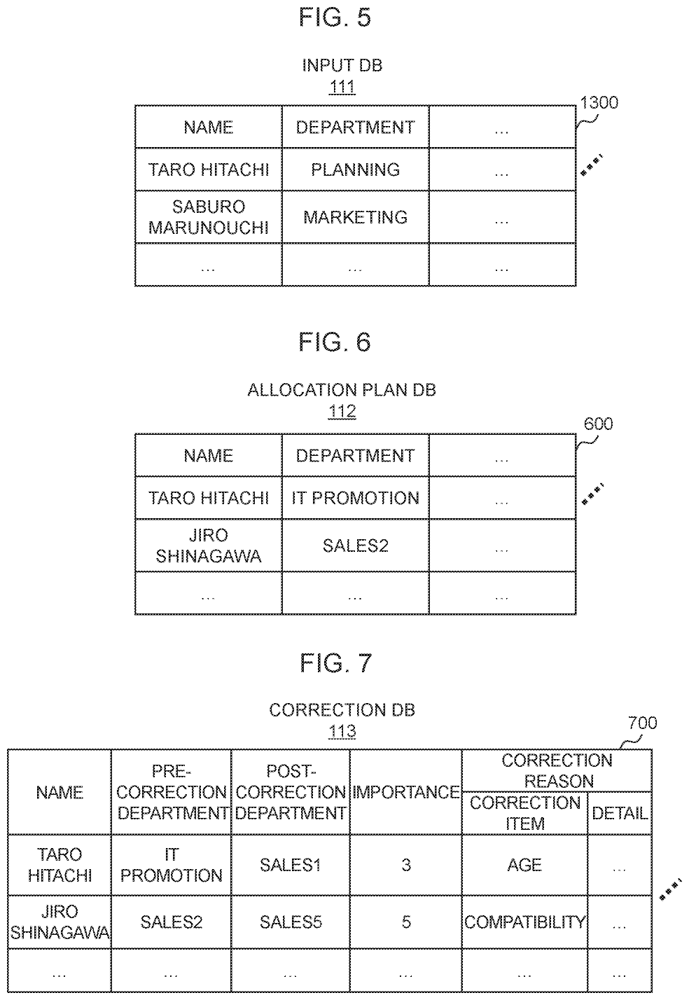

FIG. 5 illustrates an exemplary configuration of the input DB 111.

The input DB 111 includes input data 1003 for each time point. The input data 1003 indicates, for example, a name and a department for each human resource. The input data 1003 may include other information (for example, information indicating various kinds of properties such as sex, age, and service years) for each human resource. The input data 1003 is data including all or part of allocation information indicating a plurality of human resources in an organization and allocation destinations of the respective human resources, and may be data extracted from master data indicating the relation between each human resource and the corresponding allocation destination or may be data input from a system (for example, a computer system that manages the relation between each human resource and the corresponding allocation destination) outside of the human resource allocation supporting system 100.

FIG. 6 illustrates an exemplary configuration of the allocation plan DB 112.

The allocation plan DB 112 includes an allocation plan table 600 indicating an allocation plan. The allocation plan indicated by the allocation plan table 600 may be a pre-correction allocation plan generated by the allocation unit 162 or may be an allocation plan after the allocation plan is manually corrected. The allocation plan table 600 is added to the allocation plan DB 112 at each generation of an allocation plan or at each correction of an allocation plan. The allocation plan table 600 indicates a name and a department for each human resource, the allocation destination of which is to be changed. The allocation plan table 600 may include other information (for example, information indicating various kinds of properties such as sex, age, and service years) for each human resource.

Human resources indicated by the allocation plan table 600 are each a human resource, the allocation destination of which is to be changed, and thus are some or all human resources indicated by the input DB 111. When the allocation plan table 600 indicating an employed allocation plan is reflected onto the input DB 111, the input data 1003 indicating latest allocation (allocation of human resources in the organization) to which the employed allocation plan is applied is added to the input DB 111. Note that as described above, no input DB 111 may be provided, and input data for allocation plan generation may be input from an external system.

FIG. 7 illustrates an exemplary configuration of the correction DB 113.

The correction DB 113 includes a correction table 700 indicating correction contents. The correction table 700 is added to the correction DB 113 at each correction of an allocation plan. The correction table 700 indicates the contents of manual correction performed through the correction contents 303 of the allocation plan UI 160. Specifically, for each human resource, the post-change department of which is corrected in an allocation plan, the correction table 700 indicates a name, a pre-correction department (post-change department in the allocation plan before correction), a post-correction department (post-change department after correction), an importance (importance of correction for the human resource), a correction reason (correction item (item to which the correction reason corresponds) and details (details of the correction reason)).

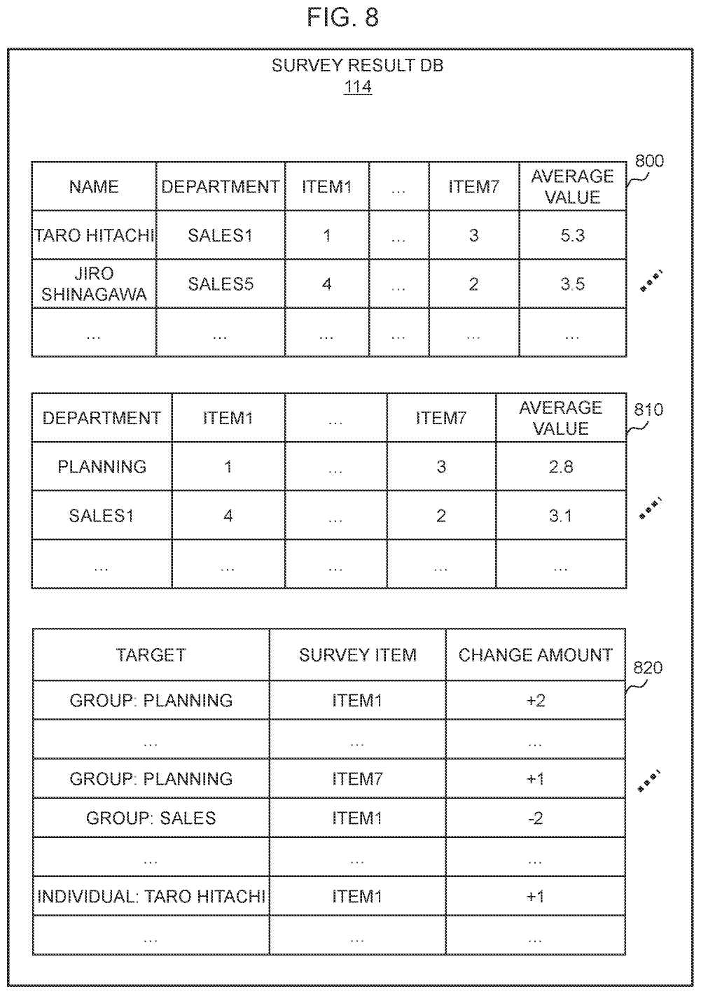

FIG. 8 illustrates an exemplary configuration of a survey result DB 114.

The survey result DB 114 includes an individual survey result table 800, a group survey result table 810, and a table 820 indicating an effect measurement result.

The individual survey result table 800 indicates a result (score provided to each human resource for each of survey items 1 to 7) of an individual survey of an allocation plan. Specifically, for example, the individual survey result table 800 indicates, for each human resource, a department at the allocation destination of the human resource, a score provided for each of survey items 1 to 7, and the average value of the scores. The individual survey result table 800 is added each time an individual survey of an allocation plan is performed. Note that the average value of the scores is an exemplary statistical value of the scores, and a statistical value of another kind such as the sum value in place of the average value may be employed.

The group survey result table 810 indicates a result (score provided to each department for each of survey items 1 to 7) of a group survey of an allocation plan. Specifically, for example, the group survey result table 810 indicates, for each department, a score provided for each of survey items 1 to 7 and the average value (exemplary statistical value) of the scores. The group survey result table 810 is added each time a group survey of an allocation plan is performed.

The effect measurement result table 820 indicates a result of an effect measurement (comparison between a latest survey result and a past survey result). Specifically, for example, the effect measurement result table 820 indicates, for each target of a survey, the change amount of each of survey items 1 to 7. As described above, the target is any of a human resource, all human resources, a department, and all departments.

An already known method may be employed as a method of a survey (for example, an individual survey or a group survey) of an allocation plan.

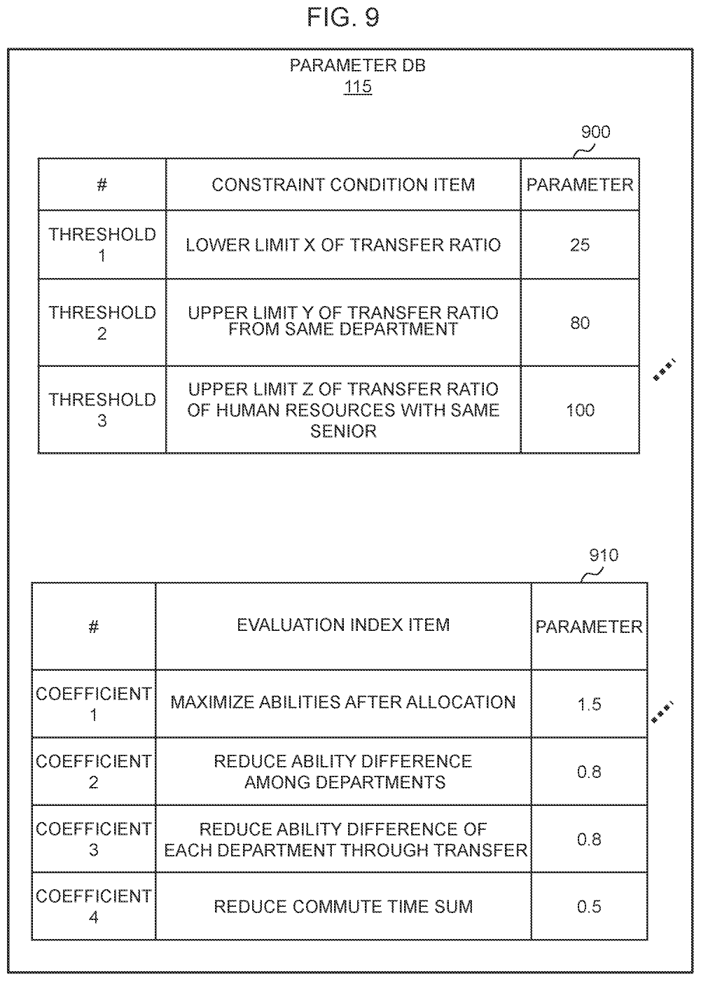

FIG. 9 illustrates an exemplary configuration of a parameter DB 115.

The parameter DB 115 includes a parameter group used in the learning phase and a calculated optimum parameter group. Specifically, the parameter DB 115 includes a constraint condition parameter table 900 and an evaluation index parameter table 910.

The constraint condition parameter table 900 indicates a parameter used for each of a plurality of constraint condition items. The evaluation index parameter table 910 indicates a parameter used for each of a plurality of evaluation index items. The constraint condition parameter table 900 and the evaluation index parameter table 910 are added at each use of a parameter group.

The learning phase will be described below.

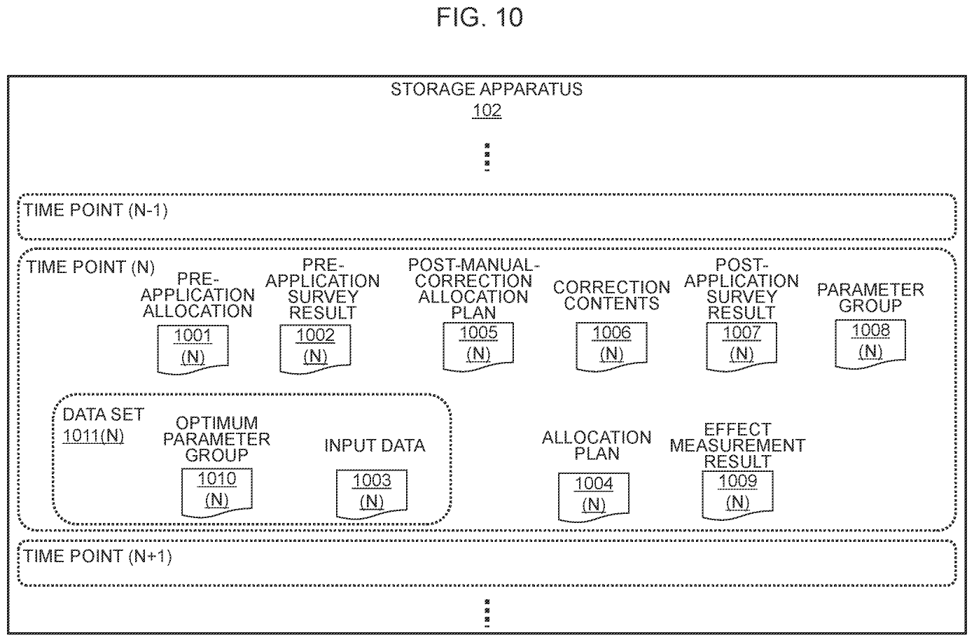

FIG. 10 schematically illustrates an outline of an example of data for each of a plurality of time points.

Data such as a pre-application allocation 1001, a pre-application survey result 1002, the input data 1003, an allocation plan 1004, a post-manual-correction allocation plan 1005, correction contents 1006, a post-application survey result 1007, and a parameter group 1008 can be acquired from the storage apparatus 102 for each of a plurality of time points. Data 1001(N) to 1008(N) for one time point (N) before start of the learning phase will be described as an example. In FIG. 10, “(X)” (X= . . . , N+1, N, N−1, . . . ) is appended to the end of the reference sign of data for time point (X). The previous time point of the time point (N) is the time point (N−1).

The pre-application allocation 1001(N) may be data acquirable from the input DB 111 and indicates allocation at the time point (N). The pre-application survey result 1002(N) may be data acquirable from the survey result DB 114 and indicates a result of a survey (in the present embodiment, an individual survey or a group survey) of pre-application allocation 1001(N). In other words, the pre-application allocation 1001(N) may be data based on the post-manual-correction allocation plan 1005(N−1) (for example, the post-manual-correction allocation plan 1005(N−1) itself) at the previous time point (N−1), and the pre-application survey result 1002(N) and may be the post-application survey result 1007(N−1) at the previous time point (N−1).

The input data 1003(N) is data acquirable from the input DB 111 and input data for generation of an allocation plan for the time point (N). The input data 1003(N) includes all or part of the pre-application allocation 1001(N). In the present embodiment, the input data 1003(N) is data extracted from the pre-application allocation 1001(N) but may be data input from an external system.

The allocation plan 1004(N) is data acquirable from the allocation plan DB 112 and indicates an allocation plan generated by the allocation unit 162 based on the input data 1003(N) and the parameter group 1008(N).

The post-manual-correction allocation plan 1005(N) is data acquirable from the allocation plan DB 112 and indicates an allocation plan obtained by performing manual correction of the allocation plan 1004(N).

The correction contents 1006(N) are data acquirable from the correction DB 113 and indicate the contents of manual correction of the allocation plan 1004(N).

The post-application survey result 1007(N) is data acquirable from the survey result DB 114 and indicates a result of a survey of the post-manual-correction allocation plan 1005(N).

The parameter group 1008(N) is data acquirable from the parameter DB 115 and is a parameter group used to generate the allocation plan 1004(N) based on the input data 1003(N).

The effect measurement result 1009(N) is data acquirable from the survey result DB 114 and based on the difference between the post-application survey result 1007(N) and the pre-application survey result 1002(N). Note that a “difference” is an exemplary comparison result. For example, the effect measurement result 1009(N) may be calculated by comparing the post-application survey result 1007(N) with a survey result (for example, a survey result including a statistical value of the survey items) based on the survey results 1002 for a plurality of time points before the time point (N).

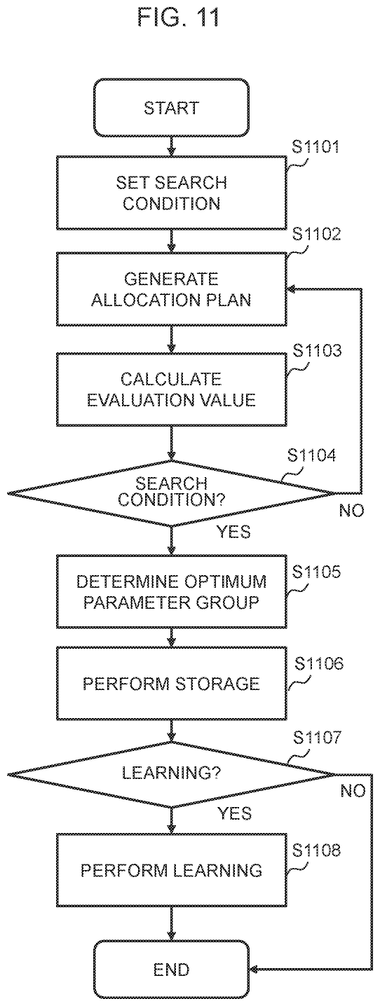

The optimum parameter group 1010(N) is a calculated and optimized parameter group. Note that the optimum parameter group 1010(N) is calculated in learning processing in an example in FIG. 11 to be described later but may be calculated at a timing different from the learning processing. More specifically, for example, the learning unit 171 may be divided into a parameter calculation unit that is a function for calculating an optimum parameter group, and a model learning unit configured to perform learning of the optimum parameter model 131 based on the calculated optimum parameter group.

FIG. 11 illustrates a flowchart of the learning processing. Note that in the following description, “high” and “low” of a value such as an importance or a change amount may be being equal to or larger than a threshold value of the value and being smaller than the threshold value, respectively. The “threshold value” of the value may be a predetermined static value or may be a value dynamically determined as a relative value.

S1101 to S1106 are performed for each of a plurality of time points (for example, a plurality of time points before start of the learning phase). Description is made on one time point (N) as an example.

The learning unit 171 sets a search condition (S1101). The “search condition” is a parameter range for each condition item. For example, an initial parameter is provided for each condition item, and a parameter range is set with respect to the initial parameter. S1102 and S1103 are performed for each of N (N is a natural number) parameter groups (parameter combinations). Each “parameter group” is a set of a plurality of parameters corresponding to a plurality of condition items, and each parameter is a parameter belonging to a parameter range for a condition item corresponding to the parameter.

The learning unit 171 selects an unused parameter group in the search condition set at S1101 and causes the allocation unit 162 to generate an allocation plan based on the selected parameter group and the input data 1003 (S1102). The “unused parameter group” is an example of a given parameter group and is a parameter group yet to be unused among N (for example, all) parameter groups.

The learning unit 171 calculates an evaluation value of the allocation plan generated at S1102 based on comparison between the allocation plan and correct data (for example, the post-manual-correction allocation plan 1005(N)) (S1103).

The learning unit 171 determines whether N parameter groups that obey the search condition set at S1101 have been used (S1104). When a result of the determination at S1104 is false, the processing returns to S1102.

When a result of the determination at S1104 is true, the learning unit 171 determines an optimum parameter group (S1105). Specifically, the learning unit 171 selects an allocation plan having the highest evaluation value among the allocation plans generated through the loop of S1102 to S1104, and optimizes a parameter group used to generate the selected allocation plan.

The learning unit 171 stores the optimized parameter group in the parameter DB 115 (S1106). Accordingly, the optimum parameter group for the time point (N) exists in the storage apparatus 102.

The learning unit 171 determines whether a learning execution condition is satisfied (S1107). The learning execution condition may be that, for example, the processing at S1101 to S1107 has been performed for each of P time points (P is a natural number), in other words, the processing at S1101 to S1107 has been performed P times. Accordingly, the learning execution condition is that a data set necessary for learning (for example, new establishment or relearning) of the optimum parameter model 131 is accumulated in the storage apparatus 102.

When a result of the determination at S1107 is true, the learning unit 171 performs learning of the optimum parameter model 131 (S1108). A data set for each of P time points is used for learning of the optimum parameter model 131. For each time point, the “data set” includes an optimum parameter group for the time point and input data (or the characteristic amount of the input data) corresponding to the time point. When S1101 to S1107 are performed for each of one or more time points before start of the learning phase, the data set for each time point exists in the storage apparatus 102. Note that as described above, the calculation (for example, S1101 to S1106) of the optimum parameter group 1010 and the model learning (S1108) using a data set may be performed out of synchronization (may be separated). For example, the calculation of the optimum parameter group 1010 may be periodically automatically performed, and the model learning using a data set may be performed when the model learning is explicitly instructed by the user through a UI.

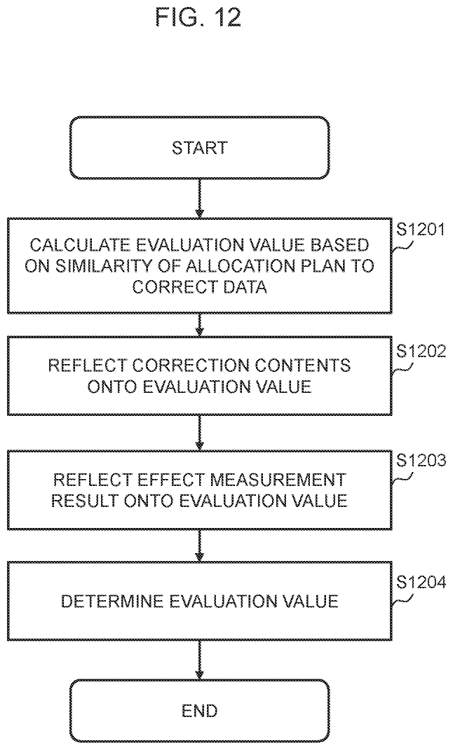

FIG. 12 illustrates a detailed flowchart of S1103 in FIG. 11. Description of FIG. 11 is made on one allocation plan as an example.

The learning unit 171 calculates an evaluation value based on the similarity between an allocation plan and correct data (S1201). For example, the evaluation value is higher as the similarity is higher, and the evaluation value is lower as the similarity is lower.

The learning unit 171 applies the correction contents 1006(N) to the evaluation value calculated at S1201 (S1202). Specifically, for example, the learning unit 171 updates the evaluation value calculated at S1201 based on the relation between each of parts of the allocation plan, which match and differ from the correct data, and an importance in the correction contents 1006(N). More specifically, for example, at least one of (A) and (B) described below may be employed.

(A) At least one of (a1) and (a2) described below may be employed as an example of a case (addition case) in which the evaluation value is set to be higher.
(a1) The part of the allocation plan, which matches the correct data corresponds to a part of a high importance (for example, the allocation destination of a human resource in the allocation plan matches a post-correction allocation destination, and the post-correction allocation destination corresponds to correction of a high importance).
(a2) The part of the allocation plan, which differs from the correct data corresponds to a part of a low importance (for example, the allocation destination of a human resource in the allocation plan differs from a post-correction allocation destination, but the post-correction allocation destination corresponds to correction of a low importance).
(B) At least one of (b1) and (b2) described below may be employed as an example of a case (subtraction case) in which the evaluation value is set to be lower.
(b1) The part of the allocation plan, which matches the correct data corresponds to a part of a low importance (for example, the allocation destination of a human resource in the allocation plan matches a post-correction allocation destination, but the post-correction allocation destination corresponds to correction of a low importance).
(b2) The part of the allocation plan, which differs from the correct data corresponds to a part of a high importance (for example, the allocation destination of a human resource in the allocation plan differs from a post-correction allocation destination, and the post-correction allocation destination corresponds to correction of a high importance).

The learning unit 171 applies, to the evaluation value updated at S1202, an effect measurement result based on the difference between the post-application survey result 1007(N) and the pre-application survey result 1002(N) (S1203). Specifically, for example, the learning unit 171 updates the evaluation value updated at S1202 based on the relation between each of parts of the allocation plan, which match and differ from the correct data, and a change amount statistical value (change amount statistical value specified based on the effect measurement result) related to the part. More specifically, for example, at least one of (C) and (D) described below may be employed. The “change amount statistical value” at S1203 may be a statistical value of the change amounts of all or some of survey items 1 to 7 (for example, any survey item selected by the user through the survey analysis UI 180 among survey items 1 to 7).

(C) At least one of (c1) and (c2) described below may be employed as an example of a case (addition case) in which the evaluation value is set to be higher.
(c1) The part of the allocation plan, which matches the correct data corresponds to a part of a high change amount statistical value (for example, the allocation destination of a human resource in the allocation plan matches a post-correction allocation destination, and at least one of the human resource and the post-correction allocation destination corresponds to a human resource or department of a high change amount statistical value).
(c2) The part of the allocation plan, which differs from the correct data corresponds to a part of a low change amount statistical value (for example, the allocation destination of a human resource in the allocation plan differs from a post-correction allocation destination, but at least one of the human resource and the post-correction allocation destination corresponds to a human resource or department of a low change amount statistical value).
(D) At least one of (d1) and (d2) described below may be employed as an example of a case (subtraction case) in which the evaluation value is set to be lower.
(d1) The part of the allocation plan, which matches the correct data corresponds to a part of a low change amount statistical value (for example, the allocation destination of a human resource in the allocation plan matches a post-correction allocation destination, but at least one of the human resource and the post-correction allocation destination corresponds to a human resource or department of a low change amount statistical value).
(d2) The part of the allocation plan, which differs from the correct data corresponds to a part of a high change amount statistical value (for example, the allocation destination of a human resource in the allocation plan differs from a post-correction allocation destination, and at least one of the human resource and the post-correction allocation destination corresponds to a human resource or department of a high change amount statistical value).

The learning unit 171 determines an evaluation value of the allocation plan based on the evaluation value updated at S1203 (S1204). The determined evaluation value may be the evaluation value updated at S1203 or may be an evaluation value obtained by performing processing on the updated evaluation value.

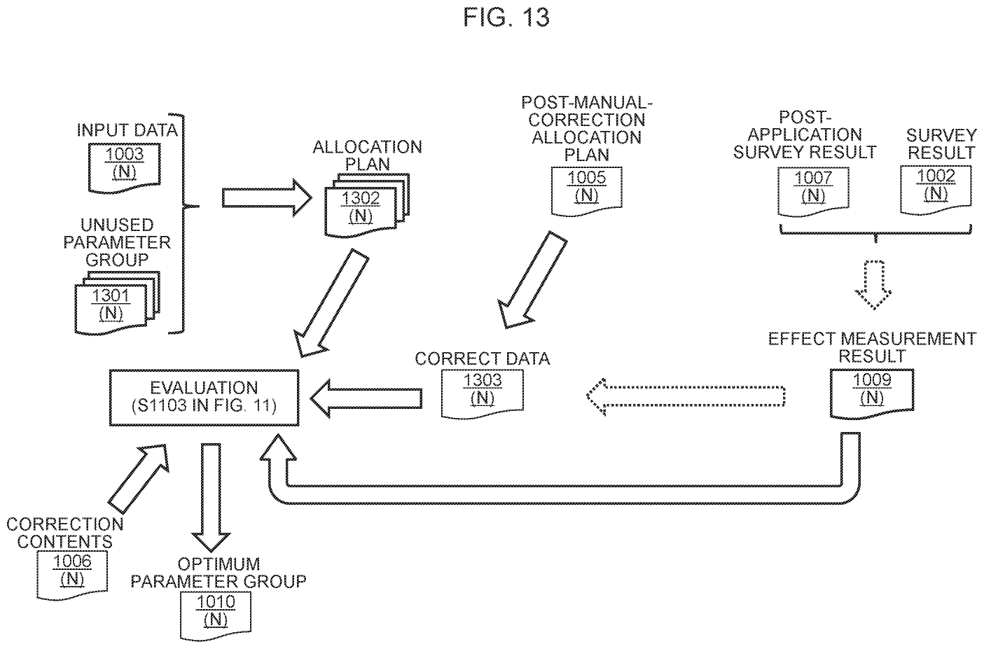

FIG. 13 schematically illustrates an example of calculation of an optimum parameter group in the learning processing. Description of FIG. 13 is made on one time point (N) as an example.

At each selection of unused parameter group 1301(N) in the range of the search condition, the learning unit 171 causes the allocation unit 162 to generate an allocation plan 1302(N) based on the input data 1003(N) and the selected unused parameter group 1301(N). Accordingly, the allocation plan 1302(N) for each selected unused parameter group (N) is obtained.

The learning unit 171 performs calculation (S1103 in FIG. 11) of the evaluation value of each allocation plan 1302(N) by using the correct data 1303(N), the correction contents 1006(N), and the effect measurement result 1009(N). The correct data 1303(N) is the post-manual-correction allocation plan 1005(N). Note that the correct data 1303(N) may be an allocation plan obtained by applying the effect measurement result 1009(N) to the post-manual-correction allocation plan 1005(N).

The learning unit 171 sets the optimum parameter group 1010(N) to be the parameter group 1301(N) used to generate the allocation plan 1302(N) of the highest evaluation value and stores the optimum parameter group 1010(N) in the storage apparatus 102 (parameter DB 115).

According to the present embodiment, the following description is made, for example.

The post-manual-correction allocation plan 1005(N) may be the correct data 1303(N) (in other words, an optimum solution) for the input data 1003(N). The post-manual-correction allocation plan 1005(N) is not necessarily appropriate as the correct data 1303(N) (for example, the post-manual-correction allocation plan 1005(N) is not necessarily constantly appropriate), and thus the effect measurement result 1009(N) based on the difference between the post-application survey result 1007(N) as a survey result of the post-manual-correction allocation plan 1005(N) and the pre-application survey result 1002(N) as a post-application survey result for the previous time point (N−1) is used for processing (for example, evaluation of the allocation plan 1302(N)) for determination of the optimum parameter group 1010(N).

It is thought to be difficult to constantly calculate a parameter group for obtaining an allocation plan for which no manual correction is unnecessary even when the optimum parameter model 131 is optimized through learning of the optimum parameter model 131. Thus, the optimum parameter model 131 is learned based on the importance of each correction included in the correction contents 1006, and it is expected to calculate, in the inference phase, a parameter group for generating an allocation plan for which manual correction of a high importance is unlikely to be needed.

Several specific examples of parameters and parameter optimization will be described below. In the description, the following assumption is made.

Constraint condition item 1 is that “the number of human resources allocatable to department A is equal to or smaller than X”. The value X is a parameter (continuous value).

Constraint condition item 2 is that “the number of human resources allocatable to department B is equal to or smaller than Y”. The value Y is a parameter (continuous value).

Constraint condition item 3 is that “the allocation destination of AAA is department B”. The value AAA is a parameter (discrete value) of the name of a human resource.

Evaluation index item 1 is that “abilities of department A are improved”. The normalized value of the sum of abilities of human resources allocated to department A is represented by —1.

Evaluation index item 2 is that “abilities of department B are improved”. The normalized value of the sum of abilities of human resources allocated to department B is represented by E2.

There is an objective function (objective variable=w1*E1+w2*E2) as a combination of evaluation indexes multiplied by weight coefficients. Parameters of evaluation index items 1 and 2 are w1 and w2 (both are continuous values). The weight coefficients w1 and w2 with which the objective variable is highest are optimum parameters.

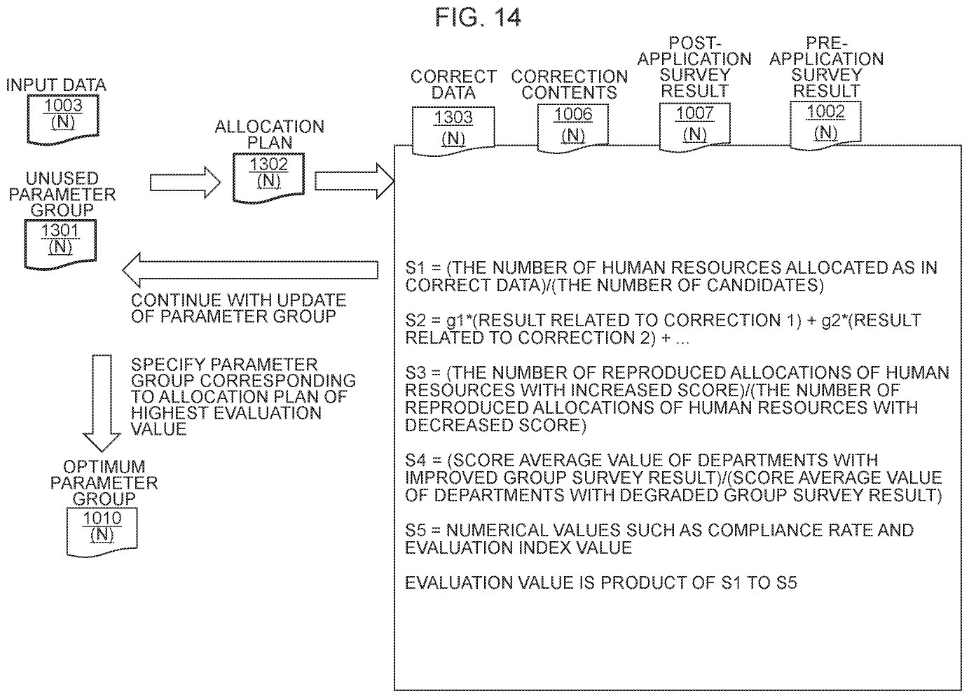

FIG. 14 schematically illustrates an example of calculation of parameters (continuous values).

The allocation plan 1302(N) is generated based on the input data 1003(N) and the unused parameter group 1301(N). The evaluation value of the allocation plan 1302(N) is calculated as described below. Note that at least one of S1 to S5 described below may be normalized as necessary.

First, the value S1 is calculated based on a result of comparison between the allocation plan 1302(N) and the correct data 1303(N). The value S1 is given by S1=(the number of human resources each having an allocation destination same as that in the correct data 1303(N) among human resources indicated by the allocation plan 1302(N))/(the number of candidates (in other words, the number of all human resources indicated by the allocation plan 1302(N))).

Secondly, the value S2 based on the correction contents 1006(N) is calculated. The value S2 is given by S2=g1*(result related to correction 1)+g2(result related to correction 2)+ . . . . The value gα (α=1, 2, . . . ) is the importance of correction α. The value of “result related to correction α” is “1” when the allocation plan 1302(N) matches correction α, or “0” when the allocation plan 1302(N) does not match correction α.

Thirdly, the value S3 is calculated based on the individual survey result. The value S3 is given by S3=(the number of reproduced allocations of human resources having improved scores)/(the number of reproduced allocations of human resources having degraded scores). Whether the score is improved or degraded is based on a result (for example, a change amount statistical value) of subtraction of the individual survey result in the pre-application survey result 1002(N) (in other words, a survey result before allocation destination change) from the individual survey result in the post-application survey result 1007(N) (in other words, a survey result after allocation destination change). For example, a “human resource having an improved score” is a human resource for which the change amount statistical value is positive (or is positive and equal to or larger than a certain value), and “the number of reproduced allocations of human resources having improved scores” is the number of allocations (pairs of a pre-change allocation destination and a post-change allocation destination) same as those of the human resources having improved scores. A “human resource having a degraded score” is a human resource for which the change amount statistical value is negative (or is negative and equal to or smaller than a certain value), and “the number of reproduced allocations of human resources having degraded scores” is the number of allocations (pairs of a pre-change allocation destination and a post-change allocation destination) same as those of the human resources having degraded scores.

Fourthly, the value S4 based on the group survey result is calculated. The value S4 is given by S4=(a score average value of departments having improved group survey results)/(a score average value of departments having degraded group survey results). Whether the group survey result is improved or degraded is based on a result (for example, a change amount statistical value) of subtraction of the group survey result in the pre-application survey result 1002(N) from the group survey result in the post-application survey result 1007(N). For example, a “department having an improved group survey result” is a department for which the change amount statistical value is positive (or is positive and equal to or larger than a certain value), and a “department having a degraded group survey result” is a department for which the change amount statistical value is negative (or is negative and equal to or smaller than a certain value). Characteristics of human resources allocated to each of a “department having an improved group survey result” and a “department having a degraded group survey result” may be reflected onto the score of the department. The concept of S4 is, for example, as follows. Specifically, a department having an improved result has human resources suitable for the department, and a department having a degraded result has human resources not suitable for the department. Thus, it is made likely to assign, to a department having an improved result, a human resource with characteristics similar to characteristics of human resources allocated to the department, and it is made unlikely to assign, to a department having a degraded result, a human resource with characteristics similar to characteristics of human resources allocated to the department.

Fifthly, the simple numerical value S5 such as a compliance rate or an evaluation index value is specified. The value S5 may be omitted.

The learning unit 171 calculates the evaluation value of the allocation plan 1302(N) based on S1 to S5. For example, the evaluation value is given by S1*S2*S3*S4*S5. At least one of S1 to S5 may be multiplied by a weight coefficient.

As described above, the learning unit 171 changes a parameter group (selects an unused parameter group) and causes the allocation unit 162 to generate an allocation plan based on the post-change parameter group.

When the evaluation values of allocation plans with all parameter groups are obtained in this manner, the learning unit 171 specifies a parameter group corresponding to an allocation plan having the highest evaluation value and sets the parameter group as the optimum parameter group 1010(N). Note that an effect measurement result does not need to be based on both the comparison result of the individual survey result and the comparison result of the group survey result, but may be, for example, based on at least one of the comparison result of the individual survey result and the comparison result of the group survey result.

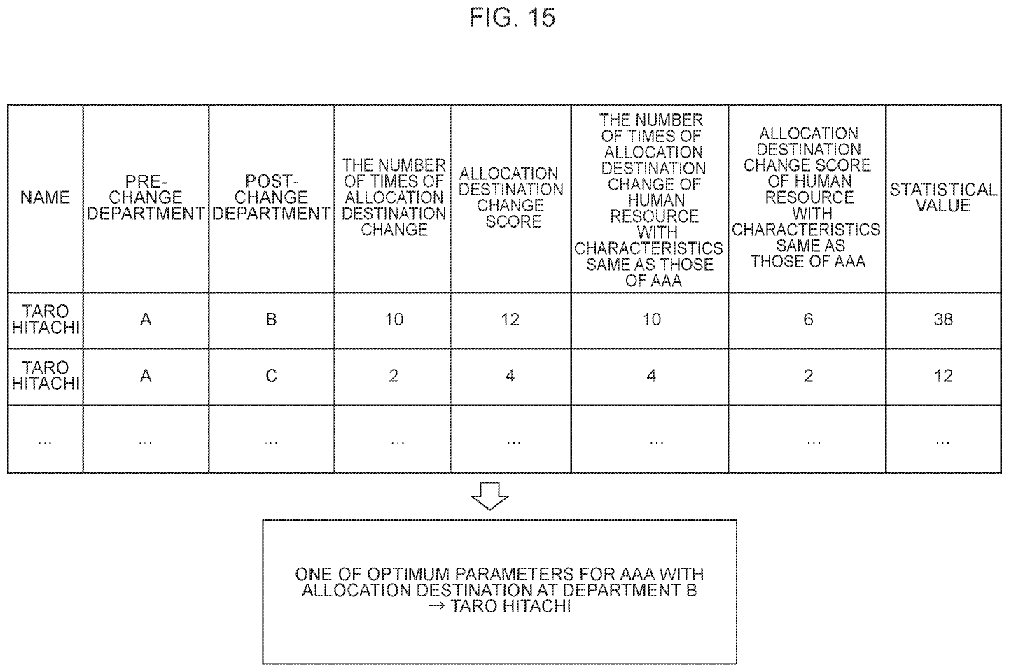

FIG. 15 schematically illustrates an example of calculation of parameters (discrete values).

The learning unit 171 performs, for example, processing described below to find an optimum value of a parameter (discrete value) “AAA”.

The learning unit 171 counts the number of times of allocation destination change for each set of a human resource, a pre-change allocation destination, and a post-change allocation destination. For example, when the number of times of allocation destination change from department A to department B is ten, the value of “the number of times of allocation destination change” is “10” as exemplarily illustrated in FIG. 15.

The learning unit 171 calculates an allocation destination change score for each set of a human resource, a pre-change allocation destination, and a post-change allocation destination. This score is based on, for example, scores in the group survey result before and after allocation destination change. The allocation destination change score is higher as change from a pre-change allocation destination to a post-change allocation destination is more appropriate.

The learning unit 171 calculates the number of times of allocation destination change of a human resource with characteristics same as those of AAA for each set of a human resource, a pre-change allocation destination, and a post-change allocation destination. The characteristics of a human resource are based on the properties (for example, age) of the human resource. In the example illustrated in FIG. 15, an example of AAA is “Taro Hitachi” and allocation destination change from department A to department B is performed only for a human resource with characteristics same as those of AAA (=“Taro Hitachi”), and thus the value of “the number of times of allocation destination change of human resource with characteristics same as those of AAA” is same as the value of “the number of times of allocation destination change”, which is “10”.

The learning unit 171 calculates the allocation destination change score of a human resource with characteristics same as those of AAA for each set of a human resource, a pre-change allocation destination, and a post-change allocation destination. This score is based on, for example, scores in the individual survey result before and after allocation destination change.

For each set of a human resource, a pre-change allocation destination, and a post-change allocation destination, the learning unit 171 calculates a statistical value (for example, the sum) of the value of “the number of times of allocation destination change”, the value of “allocation destination change score”, the value of “the number of times of allocation destination change of human resource with characteristics same as those of AAA”, and the value of “allocation destination change score of human resource with characteristics same as those of AAA”.

In the example illustrated in FIG. 15, when Taro Hitachi is at department A, it is most preferable that the post-change allocation destination is department B. Thus, one of optimum parameters for AAA with the allocation destination at department B is “Taro Hitachi”.

The present embodiment is described so far.

In the embodiment described above, an optimum parameter group is recommended to the user by the recommendation unit 161 by using the optimum parameter model 131 in the inference phase, but in place of recommendation of an optimum parameter group to the user, an optimum parameter group calculated by the recommendation unit 161 may be used to generate an allocation plan without being recommended to the user. Specifically, in the inference phase, not a parameter group set through the condition setting UI 150 but a parameter group calculated by using the optimum parameter model 131 may be used as an optimum parameter group to generate an allocation plan.

The embodiment described above can be summarized, for example, as described below.

The human resource allocation supporting system 100 includes the storage apparatus 102 and the processor 103. The storage apparatus 102 stores the input DB 111 (exemplary allocation information) indicating a plurality of human resources in an organization and the allocation destinations of the respective human resources. The processor 103 calculates the optimum parameter group 1010 by executing the optimum parameter model 131 based on the input data 1003 including all or part of the input DB 111, generates the allocation plan 1004 based on the calculated optimum parameter group (or a post-manual-correction optimum parameter group thereof) and the input data 1003 including all or part of the input DB 111, and outputs the allocation plan 1004. The optimum parameter model 131 is a machine learning model to which the input data 1003 is input and from which the optimum parameter group 1010 is output. The optimum parameter group 1010 includes an optimum parameter for each of one or more condition items related to change of the allocation destinations of the human resources. The allocation plan 1004 is a post-change allocation destination plan of each of one or more human resources of the one or plurality of human resources.

In the learning phase, for one time point (N) as an example of each of one or more time points, the processor 103 generates the allocation plan 1302(N) based on the input data 1003(N) and the parameter group 1301(N) and calculates the optimum parameter group 1010(N) based on the allocation plan 1302(N), the correct data 1303(N), and the parameter group 1301(N). In the learning phase, the processor 103 performs learning of the optimum parameter model 131 based on a data set 1011 for each of one or more time points. For each of one or more time points, the data set 1011 includes the optimum parameter group 1010 for the time point and the input data 1003 (or the characteristic amount thereof) corresponding to the time point.

In this manner, the optimum parameter model 131 is used for calculation of a parameter group for generating the allocation plan 1004 based on the input data 1003, and the correct data 1303 that obeys manual correction of the allocation plan 1004 is used for learning of the optimum parameter model 131. Accordingly, it is expected that a parameter group for generating an allocation plan that needs a small amount of manual correction is calculated by the optimum parameter model 131 subjected to learning, and therefore, it is expected that the allocation plan 1004 that needs a small amount of manual correction is generated.

The allocation plan 1004 that is preferable is different between users for the same input data 1003 (or the characteristic amount thereof). Since correct data 1303 that obeys correction contents by a user is used for learning of the optimum parameter model 131, it is expected that learning suitable for the user is performed.

For each of one or more time points, the correct data 1303 may include the post-manual-correction allocation plan 1005 of the allocation plan 1004 for the time point. Accordingly, it is expected to perform model learning that achieves the optimum parameter model 131 with which a parameter group for generating an allocation plan that needs a small amount of manual correction is likely to be calculated.

For each of one or more time points, manual correction of the allocation plan 1004 for the time point may include at least one of a correction importance and a correction item for each set of a human resource, the allocation destination of which is to be changed, the pre-correction allocation destination of the human resource, and the post-correction allocation destination of the human resource. Accordingly, it is expected to perform model learning that achieves the optimum parameter model 131 with which a parameter group for generating an allocation plan that needs a small amount of efficient manual correction is likely to be calculated based on at least one of the correction importance and the correction item and based on whether correction same as the correction occurs between the allocation plan 1302 and the correct data 1303.

For at least one of one or more time points, the processor 103 may provide the allocation plan UI 160. The allocation plan UI 160 may be an example of a UI configured to receive inputting of at least one of the correction importance and the correction item from a user for each set of a human resource, the allocation destination of which is to be changed, the pre-correction allocation destination of the human resource, and the post-correction allocation destination of the human resource. Since such a UI is provided, the correction contents 303 from the user can be efficiently received and accumulated.

For one time point (N) as an example of each of one or more time points, the processor 103 may use the effect measurement result 1009(N) to calculate the optimum parameter group 1010(N). The effect measurement result (N) may be a result of comparison between the post-application survey result 1007(N) (survey result of the post-manual-correction allocation plan 1005(N) of the allocation plan 1004(N)) and the pre-application survey result 1002(N) (exemplary of the survey result of the post-manual-correction allocation plan for each of one or more time points (for example, the time point (N−1)) before the time point (N)) (for example, may be based on a score difference obtained for each of all or some survey items 1 to 7 (examples of one or more survey items)). The correct data 1303(N) is not necessarily appropriate, but since the effect measurement result 1009(N) based on the difference between the post-application survey result 1007(N) and the pre-application survey result 1002(N) is used to calculate the optimum parameter group 1010(N), adequacy of the calculated the optimum parameter group 1010(N) is expected to be improved.

For one time point (N) as an example of each of one or more time points, the use of the effect measurement result 1009(N) may be to set the correct data 1303(N) as an allocation plan after the effect measurement result 1009(N) is applied to the post-manual-correction allocation plan 1005(N). Accordingly, the correct data 1303 is expected to be a more appropriate allocation plan after the effect measurement result 1009(N) is applied to the post-manual-correction allocation plan 1005(N), and therefore, calculation of a more appropriate optimum parameter group is expected, and thus more appropriate model learning is expected. Alternatively, the use of the effect measurement result 1009(N) may be use in the calculation of the evaluation value of the allocation plan 1302 (allocation plan candidate). Accordingly, adequacy of the evaluation value of the allocation plan 1302 is expected to be improved.

For one time point (N) as an example of each of one or more time points, the survey result of an allocation plan may include at least one of an individual survey result and a group survey result, the individual survey result including a score for each of one or more survey items for each pair of a human resource and an allocation destination in the allocation plan, and the group survey result including a score for each of the one or more survey items for each allocation destination in the allocation plan, and the effect measurement result 1009(N) may be based on at least one of a comparison result (for example, difference) of the individual survey result and a comparison result of the group survey result. Accordingly, the effect measurement result 1009(N) is obtained from at least one of a viewpoint of human resource and a viewpoint of allocation destination, and therefore, calculation of a more appropriate optimum parameter group is expected, and thus more appropriate model learning is expected.

For at least one of one or more time points, the processor 103 may provide the survey analysis UI 180. The survey analysis UI 180 may be an example of a UI configured to display, for each of one or more survey items, the difference between a survey result of a post-manual-correction allocation plan of an allocation plan for the time point and a survey result of a post-manual-correction allocation plan for each of one or more time points before the time point, and receive selection of a user-desired survey item of the one or more survey items. All or some survey items 1 to 7 may be the selected survey item. Accordingly, it is possible to perform survey result application narrowed down to a survey item in which the user is interested, and thus it is expected to perform learning of the optimum parameter model 131 from which a parameter group for generating an allocation plan that is more suitable from a viewpoint of user is calculated. Note that when any selected survey item or the number thereof is different depending on a department or a human resource, adjustment processing by normalization or another method may be performed by the processor 103 (for example, the learning unit 171). The processor 103 may display a correction item related to the selected survey item among a plurality of correction items so that the correction item can be selected by the user. Accordingly, inputting of an appropriate correction item related to a survey item is supported.

One or more condition items may include one or more items for a constraint condition as a condition that affects selection of a human resource, the allocation destination of which is to be changed, and may include one or more items for an evaluation index as a condition that affects the post-change allocation destination of a human resource, the allocation destination of which is to be changed. Accordingly, it is expected that an allocation plan including an appropriate human resource, the allocation destination of which is to be changed, and an appropriate post-change allocation destination of the human resource is generated based on the input data 1003.

The processor 103 may calculate an optimum parameter group by executing the optimum parameter model 131 based on the input data 1003, provide the condition setting UI 150 as an example of a UI configured to recommend the calculated optimum parameter group of one or more condition items to the user, generate an allocation plan based on the recommended optimum parameter group (or optimum parameter group corrected by the user through the UI) and the input data 1003, and output the allocation plan. Accordingly, the user can receive and approve recommendation of optimum parameters so that an allocation plan is generated by using the optimum parameters, and thus can efficiently perform parameter setting for generation of an allocation plan optimum for the user.

### Embodiment 2

Embodiment 2 will be described below. Any feature different from that of Embodiment 1 will be mainly described, and description of any feature common to Embodiment 1 will be omitted or simplified.

In Embodiment 1, an optimum parameter model is a machine learning model and is a model that calculates a parameter group of one or more parameters corresponding to one or more condition items. In Embodiment 2, a model of a kind different from a machine learning model, for example, a statistical estimation model is employed as an optimum parameter model. The optimum parameter model as a statistical estimation model is generated for each of a plurality of condition item groups. A “condition item group” includes one or more condition items. In the present embodiment, for simplification of description, a “condition item group” includes only one condition item.

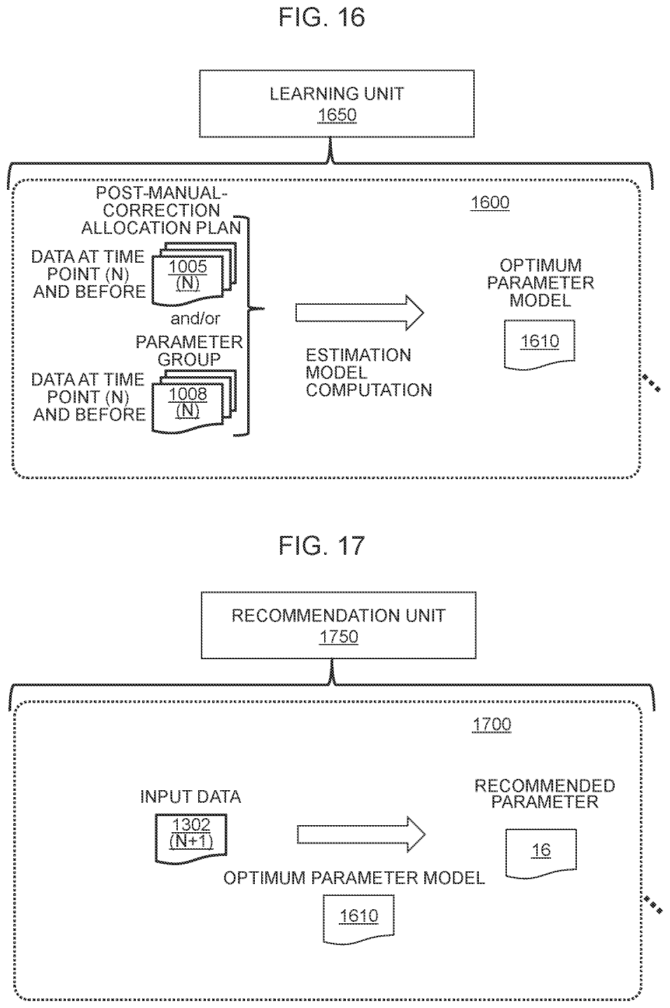

FIG. 16 illustrates an example of learning according to Embodiment 2.

A learning unit 1650 according to Embodiment 2 computes (generates) an optimum parameter model 1610 for each condition item. Specifically, for example, the learning unit 1650 performs learning 1600 illustrated in FIG. 16 for one condition item as an example.

Specifically, the learning unit 1650 computes the optimum parameter model 1610 as a statistical estimation model by performing a statistical method on at least one of the post-manual-correction allocation plan (1005(N), 1005(N−1), . . . ) corresponding to each of one or more past time points including the time point (N), and the parameter group (1008(N), 1008(N−1), . . . ) corresponding to each of one or more past time points including the time point (N). Such learning 1600 is performed for each condition item.

Note that the parameter group 1008(N) may consist of one parameter corresponding to one condition item. The parameter group 1008(N) may include a parameter manually input by the user and may include a parameter corrected by the user (for example, may include a parameter input by the user through the condition setting UI 150). When the learning 1600 is performed by using such a parameter group 1008(N), the optimum parameter model 1610 from which parameters so appropriate that manual correction is unnecessary can be recommended is expected to be generated. The optimum parameter model 1610 can be generated based on the post-manual-correction allocation plan 1005(N) in place of the parameter group 1008(N) as described above, but the post-manual-correction allocation plan 1005(N) is data onto which manual correction is reflected, and thus the optimum parameter model 1610 from which parameters so appropriate that manual correction is unnecessary can be recommended is expected to be generated.

FIG. 17 illustrates an example of recommendation according to Embodiment 2.

A recommendation unit 1750 according to Embodiment 2 performs recommendation 1700 illustrated in FIG. 17 for each condition item. For one condition item as an example, the recommendation unit 1750 receives input data 1302(N+1) for the time point (N+1) and obtains a recommended parameter 16 by using the optimum parameter model 1610 (model calculated by using data for one or more time points before the time point (N+1)) corresponding to the condition item.

Note that the optimum parameter model 1610 (in other words, condition item) may be a model that does not use the input data 1302 for parameter calculation in some cases (for example, a case in which a value such as an average value or a mode value is computed as the optimum parameter model 1610). When the optimum parameter model 1610 is such as a model, the same parameter 160 is provided as a recommendation result to the user irrespective of the input data 1302.

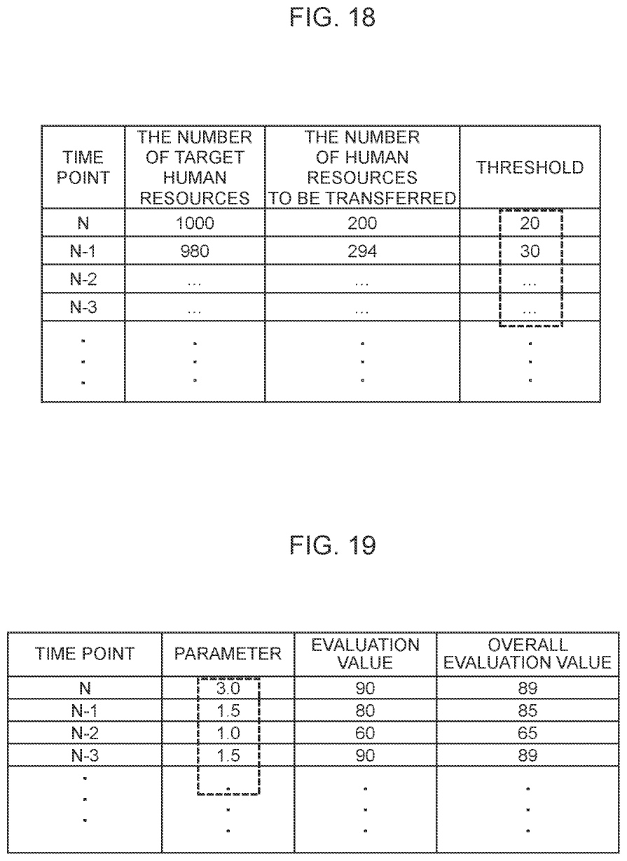

FIG. 18 illustrates a description example of model estimation based on a post-manual-correction allocation plan.

The “model estimation based on a post-manual-correction allocation plan” means computation of the optimum parameter model 1610 from the post-manual-correction allocation plan 1005. In the example illustrated in FIG. 18, a condition item is “lower limit X % of transfer ratio” as an exemplary constraint condition item. A parameter corresponding to this condition item is a parameter X (value as a threshold value 1). An optimum parameter model from which an optimum value of the parameter X is calculated is computed.

Specifically, for example, for each of the post-manual-correction allocation plans 1005(N), 1005(N−1), 1005(N−2), . . . , the learning unit 1650 calculates, based on the number of target persons (the number of human resources) and the number of persons to be transferred (the number of human resources, the allocation destinations of which are to be changed), a transfer ratio that is a ratio of the number of persons to be transferred. The learning unit 1650 performs statistical processing (processing that obeys a statistical method) on the transfer ratio calculated for each of the post-manual-correction allocation plans 1005(N), 1005(N−1), 1005(N−2), . . . , thereby computing an optimum parameter model for calculating the optimum value of the threshold value X. For example, the optimum parameter model may be a probability density function P(X), and X may be a variable of P(X). One or more values or a numerical value range in the range of X (lower limit value<X<upper limit value) corresponding to a probability range (for example, ±2σ) can be computed as a recommended parameter based on P(X).

A relational analysis method may be defined for each constraint condition item, and the tendency of a parameter corresponding to the constraint condition item may be extracted. An optional statistical method such as likelihood estimation or a probability density function may be employed as a statistical method.

FIG. 19 illustrates a description example of model estimation based on a parameter group.

The “model estimation based on a parameter group” means computation of the optimum parameter model 1610 from the parameter group 1008. In the example illustrated in FIG. 19, a condition item is “coefficient 1 of evaluation index” as an exemplary evaluation index item. A parameter corresponding to this condition item is a parameter Y. An optimum parameter model from which an optimum value of the parameter Y is calculated is computed. For example, the learning unit 1650 performs statistical processing on parameters (coefficients) obtained from parameter groups 1802(N), 1802(N−1), 1802(N−2), . . . , thereby computing an optimum parameter model for calculating the optimum value of the coefficient Y. The optimum parameter model is the mode value of the coefficient. Note that in FIG. 19, for each parameter group 1802, the evaluation value is a value based on an interest term (term including the coefficient Y and an explanatory variable) in an expression including an objective variable and a plurality of explanatory variables, and the overall evaluation value is a value based on a plurality of terms including the interest term (each term other than the interest term may be a default value). The optimum parameter model of the coefficient Y may be computed based on a statistical value (for example, the mode value) of at least one of the evaluation value and the overall evaluation value in place of or in addition to the mode value of the coefficient.

An analysis method may be defined for weights among evaluation indexes, and the tendency of parameters may be extracted. An optional statistical method may be employed as a statistical method.

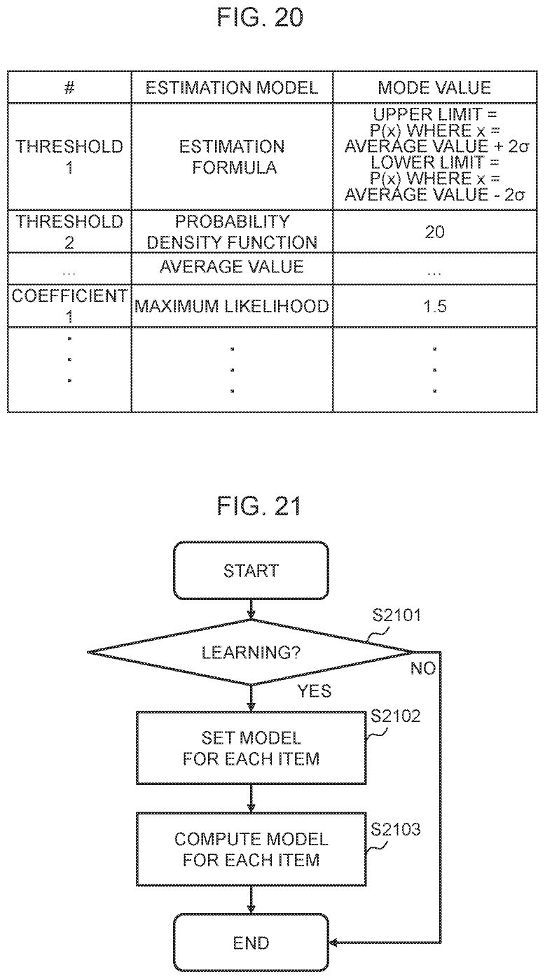

FIG. 20 illustrates an example of optimum parameter models according to Embodiment 2.

Each condition item has a parameter such as a threshold value or a coefficient, and an estimation model for calculating (estimating) optimum parameters is computed (generated) as an optimum parameter model.

In the example illustrated in FIG. 20, an estimation model (optimum parameter model) of the threshold value 1 is a probability density function, and an estimation formula is defined as an instance of the estimation model. When the optimum parameter model is an estimation model that needs an input in this manner, inputting of the input data 1302 is needed for parameter recommendation. For example, as in a case of the threshold value 1, when parameter recommendation is performed with input data as unknown data, a property value such as the number of human resources, the allocation destinations of which are to be changed, or an age ratio thereof may be input to the estimation formula.

An estimation model of a threshold value 2 is an average value, the value “20” is defined as an instance of the estimation model. When the optimum parameter model is an estimation model that does not need an input in this manner, inputting of the input data 1302 is unnecessary for parameter recommendation, and the same result (value) is recommended.

FIG. 21 illustrates a flowchart of learning processing according to Embodiment 2.

The learning unit 1650 determines whether a learning start condition is satisfied (S2101). The learning start condition may be an optional start condition such as an explicit instruction from the user to start learning or accumulation of the post-manual-correction allocation plan 1005 and the parameter group 1008 for each of p time points (p is a natural number).

When a result of the determination at S2101 is true (YES at S2101), the learning unit 1650 sets an estimation model for each condition item (S2102). The “setting” at S2102 is specification of the kind (for example, a probability density function or an average value) of each estimation model corresponding to a condition item. In place of or in addition to the specification, the “setting” of each estimation model may be setting by the user through an external interface (for example, a UI) or may be setting as an initial value in advance. A plurality of estimation models may be set for at least one condition item.

After S2102, for each condition item, the learning unit 1650 performs computation of the set estimation model (determination of an instance of the estimation model) based on at least one of the post-manual-correction allocation plan 1005 and the parameter group 1008 for each of one or more past time points (S2103).

In Embodiment 2, at least one of those described below may be employed.

For example, a condition item group includes only one condition item, but the condition item group may include, for example, two or more condition items of similar kinds, and a common optimum parameter model may be generated for the two or more condition items.

When calculating (estimating) parameters by using an estimation model that needs inputting of input data, the recommendation unit 1750 may recommend one of the estimated parameters as an optimum parameter, or may estimate a parameter range (for example, at least one of parameter upper and lower limits) based on parameters extracted from respective post-manual-correction allocation plans (in addition, parameters estimated by using the estimation model) for one or more past time points and may recommend the estimated parameter range.

When calculating (estimating) parameters by using an estimation model that does not need inputting of input data, the recommendation unit 1750 may recommend one of the estimated parameters as an optimum parameter, or may estimate a parameter range (for example, at least one of parameter upper and lower limits) based on parameters extracted from respective parameter groups (in addition, parameters estimated by using the estimation model) for one or more past time points and may recommend the estimated parameter range.

The embodiment described above can be summarized, for example, as described below.

In a human resource allocation supporting system, for each of one or more condition item groups related to change of the allocation destinations of human resources, the recommendation unit 1750 calculates an optimum parameter by using the optimum parameter model 1610 corresponding to the condition item group based on the input data 1302 based on all or part of allocation information indicating a plurality of human resources in an organization and allocation destinations of the respective human resources (or without using such input data). The allocation unit 162 can generate an allocation plan based on the optimum parameter calculated for each condition item group (or the optimum parameter subjected to manual correction) and the input data 1302 based on all or part of the allocation information, and output the allocation plan through the interface apparatus. In Embodiment 2 as well, generation of an allocation plan that needs a small amount of manual correction is expected. Note that for each condition item group, the optimum parameter may be one optimum parameter or may be parameters belonging to a parameter range constituted by a plurality of continuous or discrete parameters.

Each condition item group includes one or more condition items. For each condition item group, the learning unit 1650 computes a statistical estimation model by a statistical method that takes at least one of the post-manual-correction allocation plan 1005 and the parameter group 1008 (one or more parameters) for each of one or more time points, as an input. For each condition item group, the statistical estimation model is the optimum parameter model 1610.

In the computation of the optimum parameter model 1610, at least one of the correction contents 1006, the effect measurement result 1009, and the correct data 13003 may be used in place of or in addition to at least one of the post-manual-correction allocation plan 1005 and the parameter group 1008. The parameter group 1008 that can be used to compute the optimum parameter model 1610 may be parameters input (for example, newly input or corrected) by the user.

The embodiments are described above, but are merely exemplary for description of the present invention and not intended to limit the scope of the present invention. The present invention may be executed in another various kinds of forms. For example, Embodiments 1 and 2 may be combined. Specifically, the optimum parameter model 131 as a machine learning model common to a plurality of condition items, and the optimum parameter model 1610 as a statistical estimation model for each condition item group may be both used. Each learning unit may perform any of learning of the optimum parameter model 131 and computation of the optimum parameter model 1610. Each recommendation unit may select whether to calculate one or more optimum parameters (for example, one parameter or a parameter range) by using any of the optimum parameter model 131 and the optimum parameter model 1610, and may calculate the one or more optimum parameters by using the selected model. For example, when the amount of data used for learning of the optimum parameter model 131 is smaller than a certain amount (for example, when learning of the machine learning model is insufficient), the optimum parameter model 1610 may be selected as a model used to calculate recommendation target optimum parameters. When the amount of data used for learning of the optimum parameter model 131 is equal to or larger than the certain amount (for example, when learning of the machine learning model is sufficient), the optimum parameter model 131 may be selected as a model used to calculates recommendation target optimum parameters.

Expressions as follows may be employed based on, for example, the description of Embodiment 2.

### <Expression 1>

A human resource allocation supporting system including:

an interface apparatus; and

a processor configured to calculate an optimum parameter by using an optimum parameter model based on input data including all or part of allocation information indicating a plurality of human resources in an organization and allocation destinations of the respective human resources, generate an allocation plan based on the calculated optimum parameter or the optimum parameter subjected to manual correction and based on input data including all or part of the allocation information, and output the allocation plan through the interface apparatus, in which

an optimum parameter model is provided for each of one or more condition item group related to change of the allocation destinations of the human resources,

each condition item group includes one or more condition items,

the optimum parameter model is a statistical estimation model that is a model estimated by a statistical method,

an allocation plan is a post-change allocation destination plan of each of one or more human resources of the one or plurality of human resources, and

for each condition item group, the processor computes the optimum parameter model by a statistical method that takes, as an input, at least one of a post-manual-correction allocation plan and a parameter group for each of one or more time points.

### <Expression 2>

The human resource allocation supporting system according to expression 1, in which

the processor computes the optimum parameter model by a statistical method that takes, as an input, correction contents in place of or in addition to at least one of a post-manual-correction allocation plan or a parameter group for each of one or more time points, and

for each of the one or more time points, correction contents for the time point include at least one of a correction importance and an item corresponding to a correction reason for each set of a human resource, the allocation destination of which is to be changed, a pre-correction allocation destination of the human resource, a post-correction allocation destination of the human resource.

### <Expression 3>

The human resource allocation supporting system according to expression 2, in which

for at least one of the one or more time points, the processor provides a user interface (UI) configured to receive inputting of at least one of a correction importance and an item corresponding to a correction reason from a user for each set of a human resource, the allocation destination of which is to be changed, a pre-correction allocation destination of the human resource, a post-correction allocation destination of the human resource.

### <Expression 4>

The human resource allocation supporting system according to expression 1, in which

the processor computes the optimum parameter model by a statistical method that takes, as an input, an effect measurement result in place of or in addition to at least one of a post-manual-correction allocation plan and a parameter group for each of one or more time points, and

for each of the one or more time points, the effect measurement result is a result of comparison between a survey result that is a score provided for each of one or more survey items related to a post-manual-correction allocation plan for the time point and a survey result of a post-manual-correction allocation plan for each of one or more time points before the time point.

### <Expression 5>

The human resource allocation supporting system according to expression 1, in which

the processor computes the optimum parameter model by a statistical method that takes, as an input, correct data in place of or in addition to at least one of a post-manual-correction allocation plan and a parameter group for each of one or more time points,

for each of the one or more time points, the correct data is data of a post-manual-correction allocation plan for the time point or the post-manual-correction allocation plan to which the effect measurement result corresponding to the time point is applied, and

for each of the one or more time points, the effect measurement result is a result of comparison between a survey result that is a score provided for each of one or more survey items related to a post-manual-correction allocation plan for the time point and a survey result of a post-manual-correction allocation plan for each of one or more time points before the time point.

### <Expression 6>

The human resource allocation supporting system according to expression 1, in which the one or more condition items include

one or more items for a constraint condition as a condition that affects selection of a human resource, the allocation destination of which is to be changed, and

one or more items for an evaluation index as a condition that affects a post-change allocation destination of a human resource, the allocation destination of which is to be changed.

### <Expression 7>

The human resource allocation supporting system according to expression 1, in which the processor

calculates an optimum parameter by executing the optimum parameter model based on input data including all or part of the allocation information,

provides a UI configured to recommend the calculated optimum parameter in the one or more condition item groups to a user, and

generates an allocation plan based on the recommended optimum parameter or the optimum parameter corrected by the user through the UI and based on input data including all or part of the allocation information, and outputs the allocation plan.

Comprehensive expressions as follows may be employed based on the description of Embodiments 1 and 2. Specifically, any of a machine learning model and a statistical estimation model may be employed as the optimum parameter model, or a model of a kind other than the machine learning model and the statistical estimation model may be employed as the optimum parameter model.

### <Expression>

A human resource allocation supporting system including:

an interface apparatus; and

a processor configured to calculate an optimum parameter based on an optimum parameter model based on input data including all or part of allocation information indicating a plurality of human resources in an organization and allocation destinations of the respective human resources, generate an allocation plan based on the calculated optimum parameter or the optimum parameter subjected to manual correction and based on input data including all or part of the allocation information, and output the allocation plan through the interface apparatus, in which

the optimum parameter model is a model prepared by the processor based on data (for example, at least one of a post-manual-correction allocation plan, correct data, correction contents, and an effect measurement result) onto which a manual correction result is reflected for each of one or more time points.

### REFERENCE SIGNS LIST

100 human resource allocation supporting system

1. A human resource allocation supporting system comprising:
an interface apparatus;
a processor configured to calculate an optimum parameter group by executing an optimum parameter model based on input data including all or part of allocation information indicating a plurality of human resources in an organization and allocation destinations of the respective human resources, generate an allocation plan based on the calculated optimum parameter group or the optimum parameter group subjected to manual correction and based on input data including all or part of the allocation information, and output the allocation plan through the interface apparatus,
wherein the optimum parameter model is a machine learning model to which input data including all or part of the allocation information is input and from which an optimum parameter group is output,
wherein the optimum parameter group includes an optimum parameter for each of one or more condition items related to change of the allocation destinations of the human resources,
wherein the allocation plan is a post-change allocation destination plan of each of one or more human resources of the one or plurality of human resources,
wherein for each of one or more time points, the processor
generates an allocation plan based on input data including all or part of the allocation information corresponding to the time point and based on a given parameter group of a given parameter for each of the one or more condition items,
calculates an optimum parameter group based on the allocation plan, correct data that obeys manual correction of the allocation plan, and the given parameter group, and
performs learning of the optimum parameter model based on a data set for each of the one or more time points, and
wherein for each of the one or more time points, the data set includes an optimum parameter group for the time point, and input data including all or part of the allocation information corresponding to the time point, or a characteristic amount of the input data.

2. The human resource allocation supporting system according to claim 1, wherein for each of the one or more time points, the correct data includes a post-manual-correction allocation plan of the allocation plan for the time point.

3. The human resource allocation supporting system according to claim 1, wherein for each of the one or more time points, the manual correction of the allocation plan for the time point includes at least one of a correction importance and an item corresponding to a correction reason for each set of a human resource, the allocation destination of which is to be changed, a pre-correction allocation destination of the human resource, and a post-correction allocation destination of the human resource.

4. The human resource allocation supporting system according to claim 3, wherein for at least one of the one or more time points, the processor provides a user interface (UI) configured to receive inputting of at least one of a correction importance and an item corresponding to a correction reason from a user for each set of a human resource, the allocation destination of which is to be changed, a pre-correction allocation destination of the human resource, a post-correction allocation destination of the human resource.

5. The human resource allocation supporting system according to claim 1, wherein
for each of the one or more time points,
the processor uses an effect measurement result to calculate an optimum parameter group, and
the effect measurement result is a result of comparison between a survey result that is a score provided for each of one or more survey items related to a post-manual-correction allocation plan of the allocation plan for the time point and a survey result of a post-manual-correction allocation plan for each of one or more time points before the time point.

6. The human resource allocation supporting system according to claim 5, wherein for each of the one or more time points, the use of the effect measurement result is to set the correct data as an allocation plan after the effect measurement result corresponding to the time point is applied to a post-manual-correction allocation plan of the allocation plan for the time point.

7. The human resource allocation supporting system according to claim 5, wherein
for each of the one or more time points,
each time a parameter in a parameter range is changed, the processor generates an allocation plan candidate that is an allocation plan as a candidate, calculates an evaluation value of the allocation plan candidate, and calculates an optimum parameter group based on the allocation plan candidate, the evaluation value of which is highest, and
the use of the effect measurement result is use in the calculation of the evaluation value of the allocation plan candidate.

8. The human resource allocation supporting system according to claim 5, wherein
for each of the one or more time points,
a survey result of the allocation plan includes at least one of an individual survey result and a group survey result, the individual survey result including a score for each of the one or more survey items for each pair of a human resource and an allocation destination in the allocation plan, the group survey result including a score for each of the one or more survey items for each allocation destination in the allocation plan, and
the effect measurement result is based on at least one of a comparison result of the individual survey result and a comparison result of the group survey result.

9. The human resource allocation supporting system according to claim 5, wherein
for at least one of the one or more time points,
the processor provides a UI configured to display, for each of the one or more survey items, a result of comparison between a survey result of a post-manual-correction allocation plan of the allocation plan for the time point and a survey result of a post-manual-correction allocation plan for each of one or more time points before the time point, and receive selection of a user-desired survey item of the one or more survey items, and
all or some of the survey items are each the selected survey item.

10. The human resource allocation supporting system according to claim 8,
wherein for each of the one or more time points, the manual correction of the allocation plan for the time point includes selection of a correction item that is an item corresponding to a correction reason, and
wherein the processor displays a correction item related to the selected survey item among a plurality of the correction items so that the correction item can be selected by a user.

11. The human resource allocation supporting system according to claim 1, wherein the one or more condition items include
one or more items for a constraint condition as a condition that affects selection of a human resource, the allocation destination of which is to be changed, and
one or more items for an evaluation index as a condition that affects a post-change allocation destination of a human resource, the allocation destination of which is to be changed.

12. The human resource allocation supporting system according to claim 1,
wherein the processor
calculates an optimum parameter group by executing the optimum parameter model based on input data including all or part of the allocation information,
provides a UI configured to recommend the calculated optimum parameter group of the one or more condition items to a user, and
generates an allocation plan based on the recommended optimum parameter group or the optimum parameter group corrected by the user through the UI and based on input data including all or part of the allocation information, and outputs the allocation plan.

13. The human resource allocation supporting system according to claim 1,
wherein the processor
selects whether to use the optimum parameter model or an optimum parameter model of another kind,
when selecting use of the optimum parameter model, executes the optimum parameter model, and
when selecting use of the optimum parameter model of the other kind, calculates, for each of the one or more condition item groups, an optimum parameter by using an optimum parameter model of another kind corresponding to the condition item group based on input data based on all or part of the allocation information or without using the input data, generates an allocation plan based on the optimum parameter calculated for each condition item group or the optimum parameter subjected to manual correction and based on the input data based on all or part of the allocation information, and outputs the allocation plan through the interface apparatus,
wherein the condition item group includes one or more condition items,
wherein the optimum parameter model of the other kind is a statistical estimation model that is a model estimated by a statistical method, and
wherein for each condition item group, the processor computes the optimum parameter model of the other kind by a statistical method that takes, as an input, at least one of a post-manual-correction allocation plan and a parameter group for each of one or more time points.

14. A human resource allocation supporting method comprising:
calculating, by a computer, an optimum parameter group by executing an optimum parameter model based on input data including all or part of allocation information indicating a plurality of human resources in an organization and allocation destinations of the respective human resources,
generating, by a computer, an allocation plan based on the calculated optimum parameter group or the optimum parameter group subjected to manual correction and based on input data including all or part of the allocation information, and
outputting, by a computer, the allocation plan,
wherein the optimum parameter model is a machine learning model to which input data including all or part of the allocation information is input and from which an optimum parameter group is output,
wherein the optimum parameter group includes an optimum parameter for each of one or more condition items related to change of the allocation destinations of the human resources,
wherein the allocation plan is a post-change allocation destination plan of each of one or more human resources of the one or plurality of human resources,
for each of one or more time points,
generating, by a computer, an allocation plan based on input data including all or part of the allocation information corresponding to the time point and based on a given parameter group of a given parameter for each of the one or more condition items, and
calculating, by a computer, an optimum parameter group based on the allocation plan, correct data that obeys manual correction of the allocation plan, and the given parameter group, and
performing, by a computer, learning of the optimum parameter model based on a data set for each of the one or more time points, and
wherein for each of the one or more time points, the data set includes an optimum parameter group for the time point, and input data including all or part of the allocation information corresponding to the time point, or a characteristic amount of the input data.

15. A computer program for performing learning of an optimum parameter model for calculating an optimum parameter group used to generate an allocation plan based on input data including all or part of allocation information indicating a plurality of human resources in an organization and allocation destinations of the respective human resources,
wherein the optimum parameter model is a machine learning model to which input data including all or part of the allocation information is input and from which an optimum parameter group is output,
wherein the optimum parameter group includes an optimum parameter for each of one or more condition items related to change of the allocation destinations of the human resources,
wherein the allocation plan is a post-change allocation destination plan of each of one or more human resources of the one or plurality of human resources,
the computer program causes a computer to execute:
generating an allocation plan based on input data including all or part of the allocation information corresponding to the time point and based on a given parameter group of a given parameter for each of the one or more condition items,
for each of one or more time points, calculating an optimum parameter group based on the allocation plan, correct data that obeys manual correction of the allocation plan, and the given parameter group, and
performing learning of the optimum parameter model based on a data set for each of the one or more time points, and
wherein for each of the one or more time points, the data set includes an optimum parameter group for the time point, and input data including all or part of the allocation information corresponding to the time point, or a characteristic amount of the input data.
